(19) United States
(12) Patent Application Publication
(10) Pub. No.: US 2004/0241049 A1
(43) Pub. Date: Dec. 2, 2004

(54) Elastomeric tools for the fabrication of elastomeric devices and uses thereof

(76) Inventor: Bruce L. Carvalho, Watertown, MA (US)

Correspondence Address: Kevin E. Noonan, McDonnell Boehnen Hulbert & Berghoff LLP, 32nd Floor, 300 S. Wacker Drive, Chicago, IL, 60606, US

(21) Appl. No.: 10/818,909

(22) Filed: Apr. 5, 2004

Related U.S. Application Data
(60) Provisional application No. 60/460,465, filed on Apr. 4, 2003.

(51) Int. Cl. B01L 3/02

(52) U.S. Cl. 422/100; 425/542; 425/385; 264/328.1; 264/293

(57) ABSTRACT

The present invention is directed to flexible elastomeric tools for producing thermoplastic devices, particularly fluidics and microfluidics devices, and improved methods for fabricating such devices.

This application claims the benefit of priority to U.S. provisional patent application Ser. No. 60/460,465, filed Apr. 4, 2003, the entire disclosure of which is explicitly incorporated by reference herein.

### FIELD OF THE INVENTION

This invention relates to polymeric devices and tools for producing polymeric devices. More particularly, the invention relates to molds and tools for making thermoplastic devices. The invention specifically relates to flexible elastomeric tools for manufacturing thermoplastic devices, particularly for devices embodying fluidics or microfluidics components Methods of using said tools are also specifically provided by the invention.

### BACKGROUND OF THE INVENTION

Polymeric resins are used to produce a variety of manufactured articles and devices. Particularly useful in this regard are thermoplastic resins, which can be readily molded into almost any shape and comprise almost any moldable feature by the application of sufficient heat and pressure to melt the resin. In the practice of making articles and devices using thermoplastic resins, a mold is used. Typically, the mold is a “permanent” master, made from a metallic substrate or by photolithography on a glass or silicon base. Advantageously, such masters can be reused indefinitely; however, they are expensive and time-consuming to produce, and can be damaged by mechanical forces (such as being dropped). Alternatively, disposable molds can be produced using elastomeric compounds, most commonly polydimethylsiloxane (PMDS; see, for example, Narasimhan & Papautsky, 2004, J. Micromach. Microeng. 14: 96-103; Russo et al., 2002, Biomed. Microdev. 4: 277-283). These molds are inexpensive to produce, but their capacity to be reused is limited and they are more sensitive to, and more easily damaged by, the high temperatures required to melt some thermoplastic resins.

Particularly useful devices that can be made from thermoplastic and other polymeric resins are fluidics devices. The use of fluidic devices, particularly microfluidic devices, for chemical or biological assays and syntheses has increased rapidly over the last decade. Examples of the uses to which such devices have been put include immunoassays, enzyme assays, protein crystallization, cell separation, and nucleic acid amplification, for example using polymerase chain reaction. While the particular requirements are as broad as the class of assays and syntheses itself, most fluidic devices including microfluidic devices share a few common functions: one or a plurality of fluids, particularly in microliter quantities, are introduced onto the device and the fluids are distributed and metered to defined sites within the device where an assay or synthesis occurs. For microfluidics devices, typically these devices may be as small as a postage stamp or as large as a compact disc. On a given microfluidics device may be found tens to hundreds of input ports, channels, incubation, reaction or detection chambers and, at times, exit ports connected and arrayed in an application-specific microfluidic network. Typically, channels on such microfluidic devices have cross-sectional dimensions ranging from several microns to hundreds of microns, whereas the various ports and chambers that serve as connecting nodes for the microfluidic network are often sized to accommodate fluid volumes ranging from a few to hundreds of microliters. In some instances, surfaces within the microfluidic network are textured with submicron size posts or divots or other features that may be used as diffractive elements or, when functionalized with the appropriate chemistry, as affinity columns for select molecular or cellular species.

As such devices have become more prevalent, polymeric resins have been more frequently used for fabricating such devices instead of glass or silicon. The advantages of using polymeric resins, particularly thermoplastic embodiments thereof, include reduced cost, adequate chemical compatibility and optical properties. When polymeric resins are used, embossing and molding are the preferred methods for forming the devices and the microfluidic components thereof. Using either method, resin is brought in contact with a substrate or tool comprising a negative replica of the structures, such as fluidics structures or microfluidics structures, desired on the device. The application of an appropriate amount of pressure at a sufficient temperature (i.e., higher than the melting, or glass transition temperature, of the thermoplastic resin) and for an adequate amount of time produce the device. However, conventional tools for making such devices are prepared from inflexible materials, such as nickel and steel, resulting in difficulties in removing the finished fluidics device from the tool or mold. This is particularly true for devices having high surface area such as is common in microfluidics devices. Although the art has taught partial solutions to such problems (including, inter alia, the use of pins and other mechanical devices or mold release agents for separating the finished fluidics device from the mold), there remains a need in the art for molds and tools capable of being efficiently separated from a finished fluidics and more particularly microfluidics device, and especially wherein removal of the mold or tool can be sufficiently efficient to be automated.

### SUMMARY OF THE INVENTION

The invention provides flexible elastomeric tools for embossing and molding polymeric, most preferably thermoplastic, devices. Preferably, said devices are fluidics devices comprising fluidics structures, or more preferably microfluidics structures. Because elastomeric tools are deformable and resilient, their use allows forming and separation of flat or curved parts of a device repeatedly from a tool without significant damage to the device or signs of wear on the tool. The use of an elastomeric tool obviates the need for mold releases and the considerable mechanical forces, and the associated mechanical pins and plates, that are often required for part ejection when a metal tool is used. Silicones are the preferred materials for tool fabrication, more preferably silicone rubber elastomers and most preferably room temperature vulcanizable silicone rubber elastomers; thermoplastics such as polystyrene, polymethyl-methacrylate, polycarbonate, polypropylene and cyclic olefin copolymers are examples of resins that can be used for device fabrication.

This invention provides tools that can be easily separated from a polymeric device, such as a fluidics device or particularly a microfluidics device, that imposes no restrictions on the density or type of features or components comprising the device, and that can itself be reused for producing many copies of such devices. It is a particular advantage of the tools of this invention that said flexible, elastomeric tools have the ability to be peeled away from a molded part with the application of minimal mechanical force to the finished device. Said flexibility includes the capacity to undergo fully reversible physical deformations, and then be reused in the same fashion. For existing methods of molding, including embossing and injection molding, there are numerous ways of making tools that can be reused many times but additional features ,such as ejector pins, must be included to facilitate removal of the part. This requirement can greatly restrict the density of structures and components, such as fluidics components, the types and scale of moldable features, and efficiency and throughput of the molding process. Even using said ejector pins or other components requires the application of considerable mechanical forces to the finished device, resulting in breakage or deformation of some percentage thereof as well as limiting the types of components comprising the device to those that can withstand the required amount of mechanical (particularly shear) force. In addition, the use of an elastomeric tool makes it substantially easier to create a single tool with both macroscale and microscale features. Because a much wider range of draft angle can be used, including even zero or negative draft angles, the range and combination of features is much less restricted.

Specific preferred embodiments of the present invention will become evident from the following more detailed description of certain preferred embodiments and the claims.

### BRIEF DESCRIPTION OF THE DRAWINGS

FIG. 1 depicts cross-sectional views of the embossing process with an elastomeric tool.

FIG. 2 depicts the major components of the system used to emboss structures into thermoplastics at controlled temperatures, displacements, forces and times.

FIG. 3 depicts an oblique view of a master, elastomeric tool and an embossed part.

FIG. 4 is a cross-sectional view of 2-sided embossing.

FIG. 5 shows a plan view of a flexible, elastomeric tool according to the invention, wherein the drawing illustrates a configuration comprising a (micro)structured or unstructured base 501, a lip 502 and air vent holes 503.

FIGS. 6a through 6e show plan views of a pair of flexible, elastomeric tools of the invention, wherein tear tabs of thermoplastic resin remaining on the surface of one of the tools are easily removed by simple flexing.

FIGS. 7, 8 and 9 show plan views of a glass diffraction grating master, a silicone diffraction grating tool and an embossed acrylic diffraction grating part, respectively.

FIGS. 10a and 10b show plan views of a microstructured elastomeric tool with microposts and an embossed polypropylene part with microdivots, respectively.

FIG. 11 shows an oblique view of an embossed polypropylene part with microdivots, as shown in FIG. 10b.

FIGS. 12a and 12b show plan views of a microstructured elastomeric tool with microdivots and an embossed polypropylene part with microposts, respectively.

FIG. 13 shows an oblique view of an embossed polypropylene part with microposts, as shown in FIG. 12b.

FIG. 14 shows an oblique view of a microstructured capillary valve in a cylic olefin copolymer part.

FIGS. 15a and 15b show plan views of corresponding sections of a machined acrylic master and embossed acrylic part, respectively.

FIG. 16 shows plan views of corresponding sections of a machined acrylic master, elastomeric tool and embossed acrylic part.

FIG. 17 shows a plan view of a section of an embossed acrylic part.

FIG. 18 shows a cross-sectional view of the embossed acrylic part that is also shown in FIG. 17.

FIG. 19 shows corresponding plan views of an acrylic master (top left), embossed polypropylene part (top right), embossed polystyrene part (bottom left) and embossed acrylic copolymer part (bottom right).

FIG. 20 shows an oblique view of an embossed centrifugal microfluidics disc with overall diameter of 124 mm.

FIGS. 21a and 21b show plan views of an embossed polycarbonate part and embossed acrylic part, respectively.

FIG. 22 shows a cross-sectional view of an embossed acrylic part that depicts the ability to emboss and demold reentrant structures.

FIG. 23 shows a plan view of an acrylic part that has been embossed from two sides with air vents subsequently punctured.

FIG. 24 shows a cross-sectional view of a bonded microfluidic device.

FIG. 25 shows histogram plot of the flow rates determined on a test design that was replicated repeatedly.

FIG. 26 outlines the sequential fluidic functions of a single device within a centrifugal microfluidic device containing 96 such devices, and having the overall form factor of a compact disc.

FIG. 27 shows the fluorescence intensity as a function of drug concentration for several drug-serum protein binding assays.

### DETAILED DESCRIPTION OF PREFERRED EMBODIMENTS

This invention provides flexible, elastomeric tools for use as molds to prepare polymeric devices, more preferably fluidics and microfluidics devices. Most preferably, the polymeric devices of the invention are made from thermoplastic resins using injection molding or embossing techniques.

Many types of elastomers are useful for making the elastomeric tools of the invention. The type of elastomer used according to this invention must have a number of properties. First, the cured elastomer must not permanently deform under the temperatures used during the molding process. In practice, this requirement demands that the elastomer has a durometer greater than 60 and, furthermore, that the ceiling, or depolymerization, temperature of this elastomeric material is higher than the melting temperature of the thermoplastic resin used to fabricate the polymeric device. Preferably, the ceiling temperature of the elastomer should be at least 20 degrees Celsius, more preferably at least 40 degrees Celsius and even more preferably 80 degrees Celsius higher than that of the thermoplastic resin to be molded. Second, the type of elastomer used according to this invention must have the property that the cured elastomer is at least slightly flexible or deformable so as to afford the advantage of easier part separation from the tool after molding. As used herein, the term “elastomer” is meant to refer to any material that has at least a minimal ability to undergo reversible deformation. Deformation occurs when an applied force or forces cause an extension or compression in one or more dimensions. If the deformation is reversible, the dimensions of the elastomer return to their original values some time after the force or forces are removed. For elastomers suitable for preparing the flexible, elastomeric tools provided by the invention, there is no requirement that said elastomers return to the predeformed dimensions occur within any particular time. Preferentially, however, said return to the predeformed dimensions of the tool should occur in less than about 30 seconds, more preferably within less than about 10 seconds and even more preferably within less than about 1 second. Similarly, for elastomers suitable for preparing the flexible, elastomeric tools provided by the invention, there is no requirement that said return to the predeformed dimensions occur only after the elastomer is deformed to any particular extent. Suitable elastomers can elongate or compress as little as 0.1% and reversibly deform. Preferentially, however, the material should be capable of being deformed by about 1%, more preferably about 5% and even more preferably about 10% and still reversibly deform. In preferred embodiments, the elastomeric tools of the invention are fabricated from silicones, more preferably silicone rubber elastomers and most preferably room temperature vulcanizable silicone rubber elastomers.

The polymeric devices prepared using the flexible, elastomeric tools provided by this invention are preferably prepared from a thermoplastic resin. Thermoplastic resins are advantageously used for this purpose due to intrinsic advantageous features of these compounds, including a wide range of material characteristics, hardness, hydrophobicity, surface characteristics, chemical and biochemical compatibility, lower cost, ease of prototyping and production, and the capacity to automate production. It will be understood by those with skill in the art that the particular thermoplastic resin used to produce specific embodiments of said polymeric devices will depend on the uses to which the device is put, particularly with regard to fluidics and microfluidics device embodiments of the invention. These considerations include, inter alia interactions with chemical or biological species applied to the device. Preferred examples of said thermoplastic resins include but are not limited to polymethylmethacrylate (PMMA), cycloolefin polymers, cycloolefin copolymers, polyurethane, polystyrene, polyethylene, polypropylene, polystyrene, polycarbonate, polyvinyl chloride, polyetherether ketone and modified derivatives thereof. Alternative thermoplastic resins are known to those with skill in this art and are explicitly encompassed within the scope of this invention.

The flexible elastomeric tools of the invention are useful in producing thermoplastic embodiments of fluidics structures, including microfluidics structures defined herein as comprising one or a plurality of microchannels having cross-sectional dimensions of less than 1 mm. Preferred microfluidics structures produced using the flexible elastomeric tools of the invention include but are not limited to those described in co-owned U.S. Pat. Nos. 6,063,589, 6,143,247, 6,143,248, 6,302,134, 6,319,468, 6,319,469, 6,399,361, 6,527,432, 6,548,788, 6,582,662, 6,632,399, 6,709,869, 6,656,430, and 6,706,519, and published U.S. patent applications, Publication Nos. 2001-0055812-A1, 2002-0137218-A1, 2002-0076804-A1, 2002-0050456-A1, 2002-0106786-A1, 2002-0150512-A1, 2002-0151078-A1, 2003-0152491-A1, 2003-0195106-A1, and 2003-0232403-A1.

The flexible, elastomeric tools provided by this invention are advantageously produced using a master casting template (a “master”). The master is produced to have the desired structures (for example, fluidics devices may include structures such as input ports, channels, incubation, reaction or detection chambers and, at times, exit ports connected and arrayed in an application-specific network formed within the master). Such master templates are advantageously prepared from negative photoepoxy (SU-8) or positive photoresist (AZ4620) coated, most preferably spin coated, onto a silicon or glass solid support and the structures such as fluidics and microfluidics components produced by lithographic techniques, such as photolithography. Alternatively, silicon can be dry or wet etched, or nickel electroplating can be used to produce the desired structures. Alternatively, other materials such as stainless steel or quartz can be used. Alternatively, masters can be fabricated with high speed machining approaches that are known to those skilled in the art. Indeed, through the appropriate choice of end mills and drills and feed and spindle velocities, it is straightforward to machine microstructures and macrostructures on a metal or plastic substrate. Specific approaches for fabricating a master are described in the examples below.

An elastomeric tool is created by pouring a curable, flexible elastomeric resin onto the master and allowing the uncured material to set, forming a negative replica of the polymeric device on the surface of the elastomeric tool. As used herein, the term “negative replica” will be understood to describe the structure of the elastomeric tools of the invention, whereby the structures formed in the master are negatively (i.e., where elevations in the master are depressions in the tool and depressions in the master are elevations in the tool) formed in the tool, so that the structures in the master are produced in the devices made using the tool. After setting, the elastomeric tool is peeled from the master and is ready to be used as a tool for embossing or molding thermoplastic resins; alternatively, the tool can be further cured or treated with fluorinated hydrocarbon compounds such as carbon tri- or tetrafluoride that influence its behavior and capacity to be easily removed from the finished device made from a particular thermoplastic resin. Silicones are suitable elastomeric compounds useful for fabricating the flexible, elastomeric tools of this invention. Preferred silicones are silicone rubber elastomers, more preferably room temperature vulcanizable silicone rubber elastomers; exemplary silicones useful in the practice of this invention are KE-1600 and CX-832 obtained from Shin Etsu as described in further detail herein below. In the tool fabrication step, care must be taken to ensure that the elastomer is well mixed, free of bubbles and has a sufficient fluidity to allow it fill all of the features of the master, particularly when producing devices such as microfluidics devices that have smaller dimensions of the components thereof. In a preferred embodiment, the uncured resin is poured into the master while the master and resin are under vacuum in order to ensure that gas bubbles do not preclude the resin from properly filling the plurality of channels, chambers and reservoirs within the master.

For embossing (also termed “hot embossing” in the art), a charge of thermoplastic resin is placed onto the tool between one or several (typically two) temperature controlled plates or platens. The platen temperature is then raised above the glass transition temperature of the thermoplastic resin, and a moderate level of force (typically from 500 to about 5000, more preferably from 1000 to about 4000 and most preferably from about 2000 to about 3000 Newtons (N)) is applied to the assembly. After a dwell period at this elevated temperature and force sufficient to mold the thermoplastic resin onto the elastomeric tool, the assembly is cooled below the glass transition temperature of the resin, the applied force is released and the polymeric device is removed from the tool.

Injection molding involves mechanically fixing the flexible, elastomeric tool to the interior of a tool cavity, flowing thermoplastic resin into this cavity and against this tool at elevated temperature and pressure, holding the resin for a defined dwell period at a prescribed temperature and pressure, cooling the now structured resin and, then, releasing the pressure and ejecting the part from the tool.

The particular temperature-force-time profile that is used in either embossing or injection molding is referred to below as the TFT profile.

In each of these methods, it is advantageous to perform the molding under reduced air pressure and more preferably vacuum conditions. This advantageously facilitates removal of entrapped air (i.e., bubbles) in the thermoplastic resin, and also promotes production of polymeric devices having proper dimensions and placement of structures and components by removing air displaced by the impression of the mold onto the resin. The desired reduction in air pressure can be achieved by evacuating the chamber in which the embossing or injection molding is performed. Alternatively, the tool itself could be connected to a vacuum line that removed entrapped air between the embossing or injection molding tool and the thermoplastic resin.

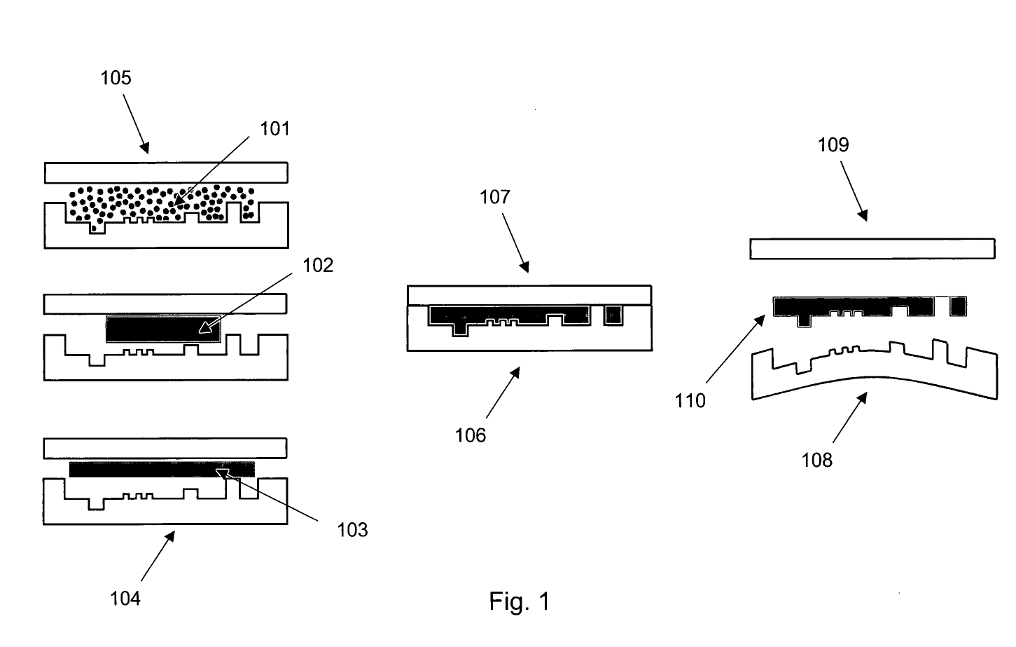

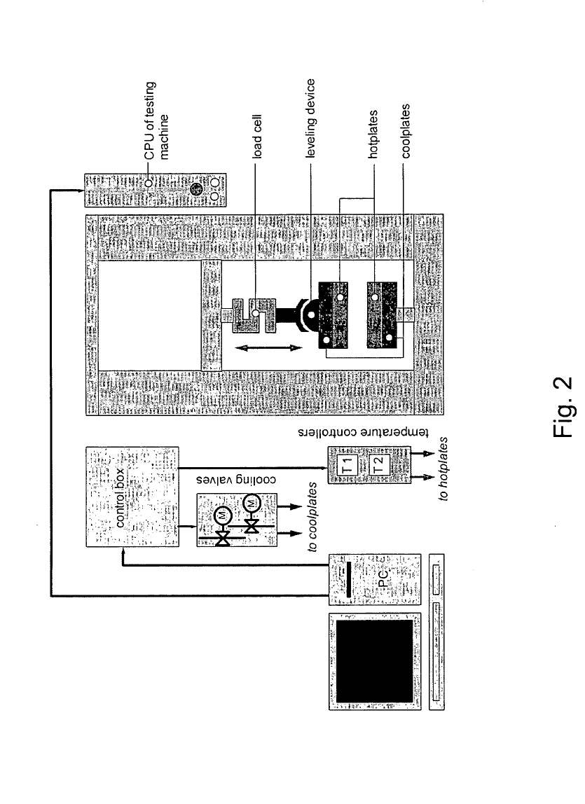

The invention can be more completely understood with regard to the drawings, where FIG. 1 provides a schematic diagram of the embossing process for single sided embossing. This figure specifically shows, in cross-section,that the initial charge of thermoplastic resin can take the form of resin beads 101, a sintered puck of resin beads 102 or a premolded plate 103; in all cases the resin charge is placed between a structured tool 104 and another surface 105; after an adequate schedule of temperature, pressure and time, the resin flows into the recessed features and around the raised features between the elastomeric tool 106 and the opposing surface 107. After the device has set, the elastomeric tool 108 is deformed and separated from the rigid, microfabricated part 110. In addition to peeling the tool from the part it also possible to force air or a mechanical pin or plate against the backside of the elastomeric tool while holding fixed the edges of the tool to cause tool deformation and part separation. FIG. 2 shows the main components of the embossing system that was used to generate many of the results shown in the Examples below. This particular embossing system, through the use of temperature sensors and force transducers and a microcomputer with appropriate I/O capabilities, provides closed-loop control of the temperature-force-time (TFT) profile during the thermoforming process. It is worth noting, however, that the elastomeric tool provided in this invention can be used with any of various heating and clamping means. While a thermal press as shown in FIG. 2 performs all the necessary functions to make use of the elastomeric tool, any means of heating and pressing will be sufficient. For example, a simple resistive heater located in one or both faces of a press can provide ample heat and pressure. A press inside an oven can also be used. An injection molding apparatus itself can work with an elastomeric tool. In all of these cases, the size and shape of the elastomeric tool may need to be slightly altered to accommodate the size and shape of the heating and clamping means. However, the basic function of the elastomeric tool in all cases is identical.

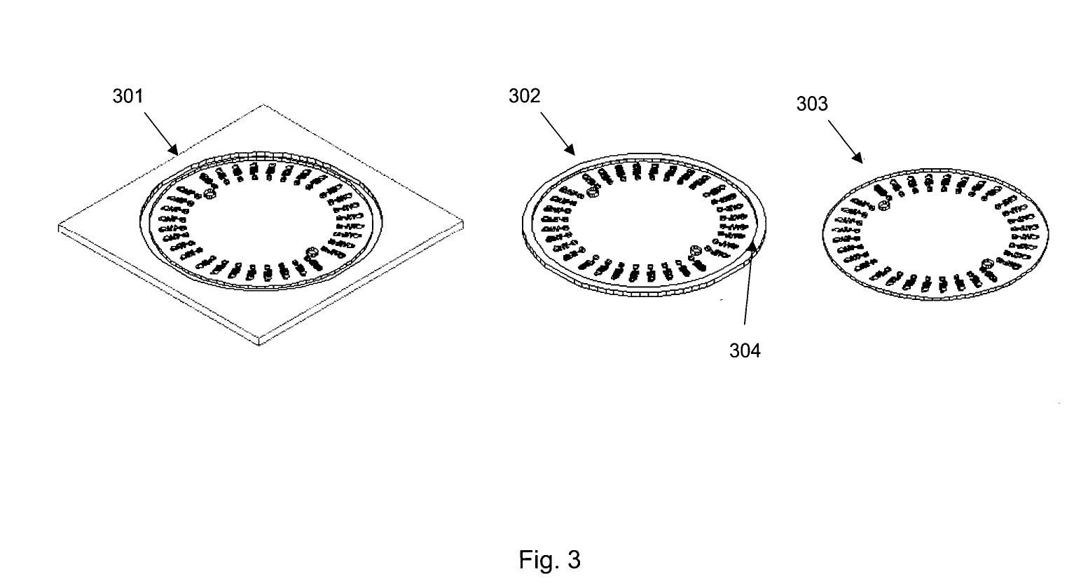

FIG. 3 are drawings of a machined acrylic master 301, elastomeric tool 302 and embossed part 303. In this Figure, the part has a form factor of a compact disc and 48 individual microfluidic manifolds are arrayed around the circumference of the embossed part. In other cases, it may be desirable to emboss a single fluidic, more preferably microfluidic manifold onto a part with an overall form factor of a compact disc. An elastomeric tool may also be used to fabricate hundreds of individual microfluidic chips simultaneously; in this case, the individual manifolds would be arrayed on the embossed part in such a way as to allow the sheet to be diced subsequent to embossing to produce the hundreds of individual chips. Note that the elastomeric tool of FIG. 3 contains a raised lip 304 that defines the outer edge or circumference of the thermoformed part by providing a physical barrier to the flow of melted thermoplastic resin. In a preferred embodiment, this tool is placed within a metal ring to limit tool expansion during the thermoforming process.

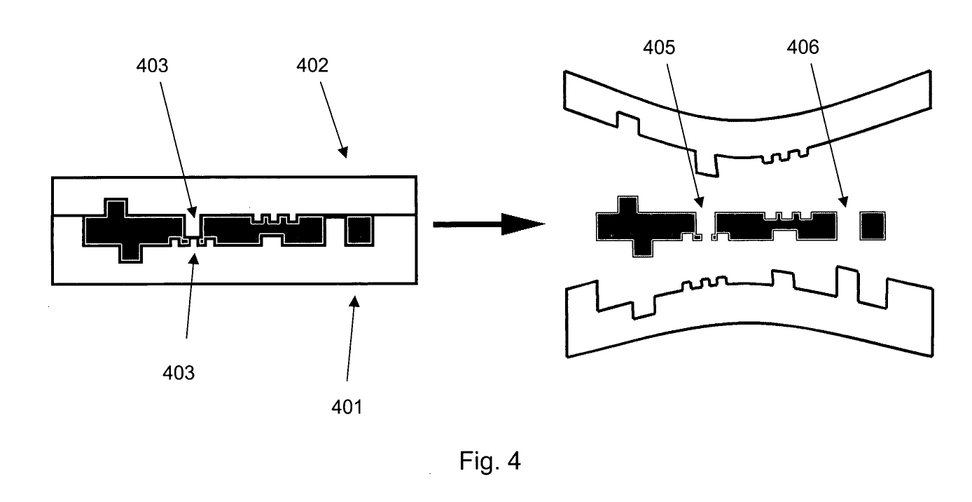

The methods of the invention also encompass two-sided embossing, as illustrated in the cross-sectional schematic of FIG. 4. Two-sided embossing is advantageously used when a component such as a through-hole is required in the device. For example, typically microfluidic devices are sealed with a lid. The sealing process may consist of thermal diffusion bonding of a plastic with properties that are similar to the part or it may involve the use of any of the methods that are generally known in the art including tape, glues, and ultrasonic welding of a thermoplastic lid to the part. In most cases, it is necessary for the sealed device to have some means of fluid and gas communication with the external world; example requirements include the need to add fluid samples, reagents to the device and the need to expel air for the proper flow of fluid throughout the otherwise sealed manifold and the need to remove fluid samples from the device for a subsequent analytical measurement. A preferred method to fabricating through-holes, and especially small diameter through-holes that do not take away from the available space on the thermoplastic substrate for microfluidic features, is to define the location of the through-hole on the elastomeric tool with a small post and to create this through-hole with two-sided embossing. FIG. 4 specifically illustrates this approach: a small post 403 from the microstructured elastomeric tool 401 makes contact with a larger post (404) from another elastomeric tool (402) that has been mounted on the top platen of the embossing station. The use of posts with disparate sizes allows for easier alignment of the two. During the actual embossing step, the thermoplastic resin flows around the now connected posts thereby creating a through-hole (405). In the event that the posts do not make contact during the embossing process but are fairly close, nevertheless, the resultant flash on the part can easily be broken away with some type of mechanical punch to also create a through-hole. FIG. 4 also depicts the formation of larger through-holes with a single post (406). The fabrication of through-holes in the microfluidic structure itself removes the need to align and bond or seal a lid with many small through-holes to this structure.

Injection molding involves mechanically fixing the tool to the interior of a tool cavity, flowing thermoplastic resin into this cavity and against this tool at elevated temperature and pressure, holding the resin for a defined dwell period at a prescribed temperature and pressure, cooling the now structured resin and, then, releasing the pressure and ejecting the part from the tool.

While peeling and other manual methods of part removal may not be preferred for a high volume process like injection molding, it is possible to use some of the elastomeric tool deformation processes described above to flex the tool, thereby separating the flexible tool from the rigid part.

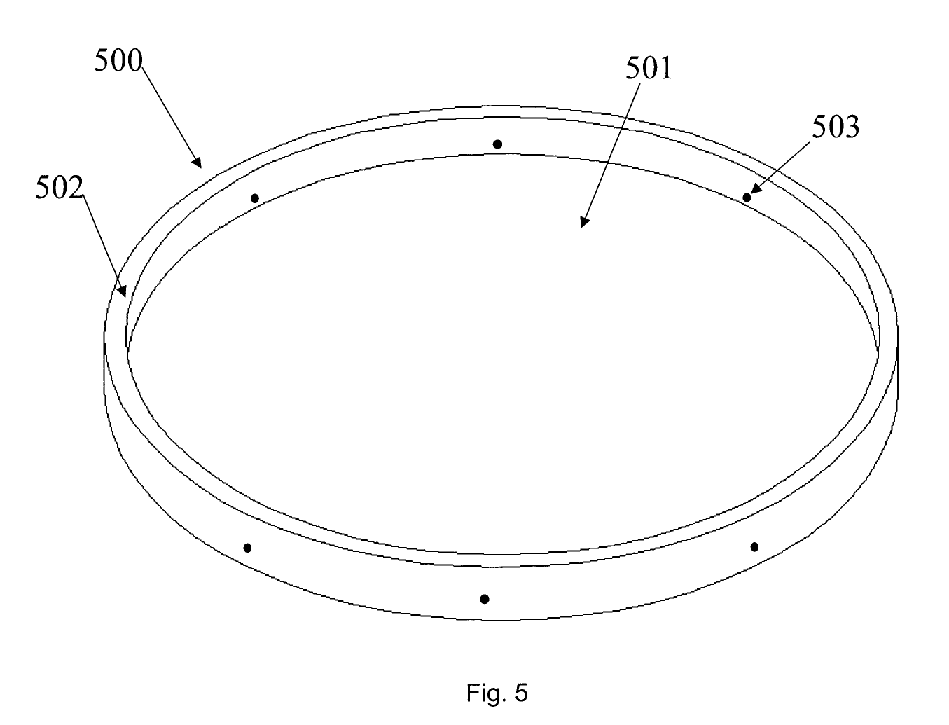

A specific embodiment of the flexible, elastomeric tools of the invention are shown in FIG. 5. In the Figure, tool 500 consist of at least a base 501. The tool can optionally contain a lip 502 that defines the outer edge or circumference of the molded part by providing a physical barrier to the flow of melted thermoplastic resin. If the elastomeric tool 500 includes a lip 502, it can also optionally include a plurality of air vents 503 that provide a means of escape for air that become trapped in the cavity formed inside the lip 502 during the molding process. Said air vents are useful in releasing from the tool air bubbles that can be formed from air entrapped when thermoplastic resin material is provided. If this air does not escape prior to the molding of the device it can become entrapped in the device itself in the form of air bubbles or voids of polymer. In some instances while using an elastomeric tool, the air can escape without the use of air vents 503 due to its high pressure. At such pressures, it is possible for the air to cause a very small, localized deformation of the tool lip 502, creating a small opening for the air to exit through. During normal operation, melted thermoplastic resin cannot exit by the same mechanism due to its substantially higher viscosity as compared to air. For the same pressure, polymer would require a much larger air hole or local deformation of the lip 502 in order to escape.

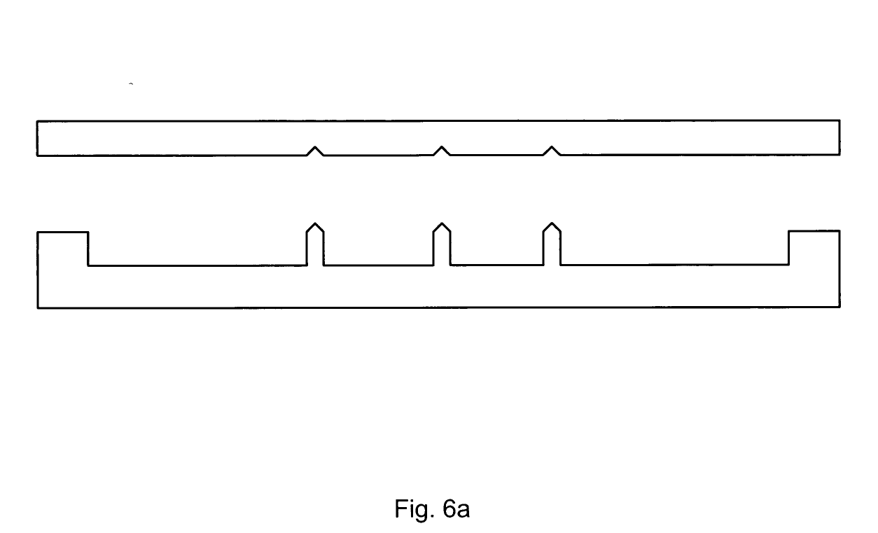

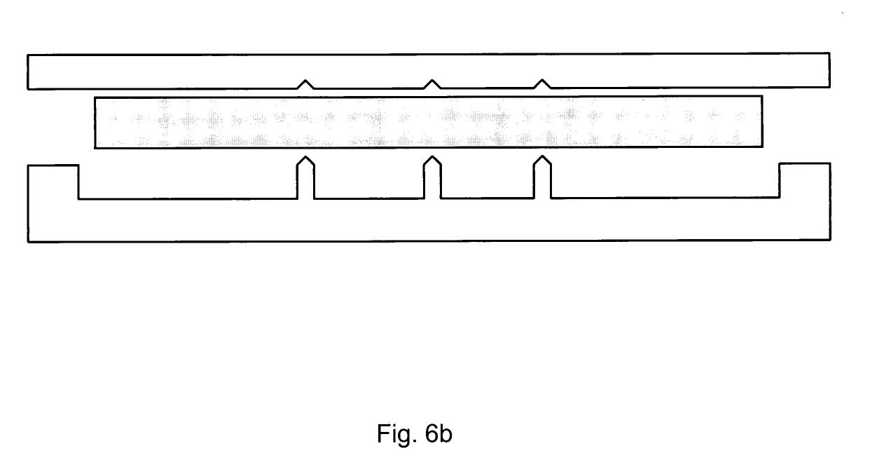

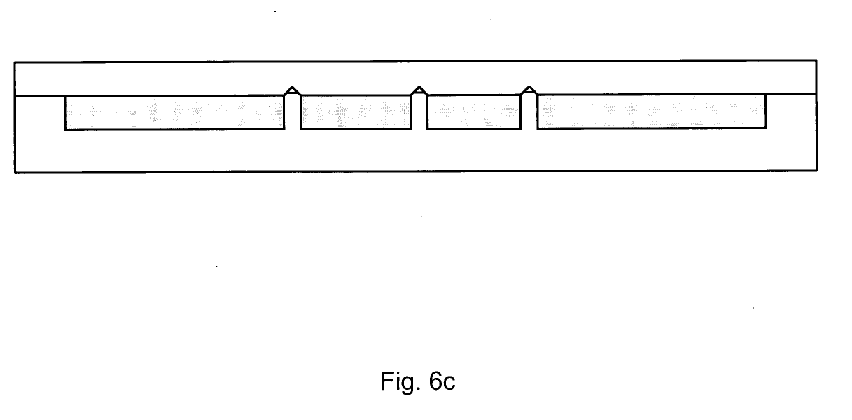

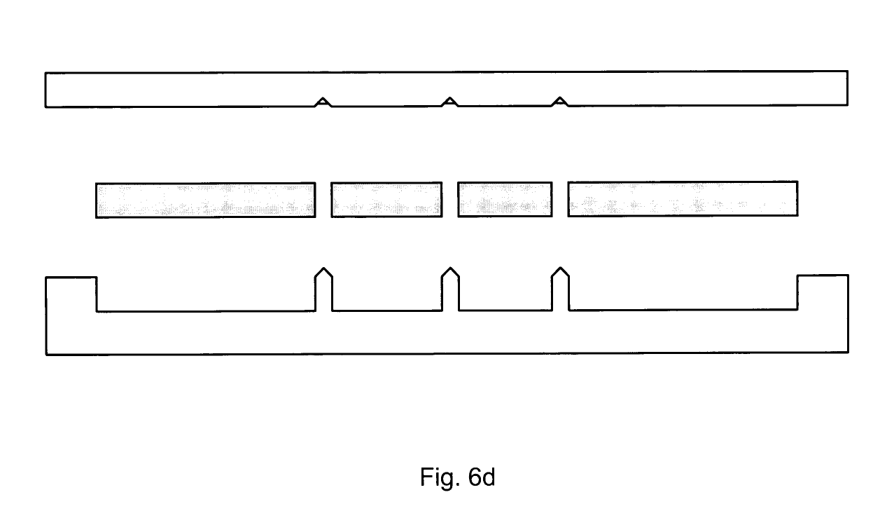

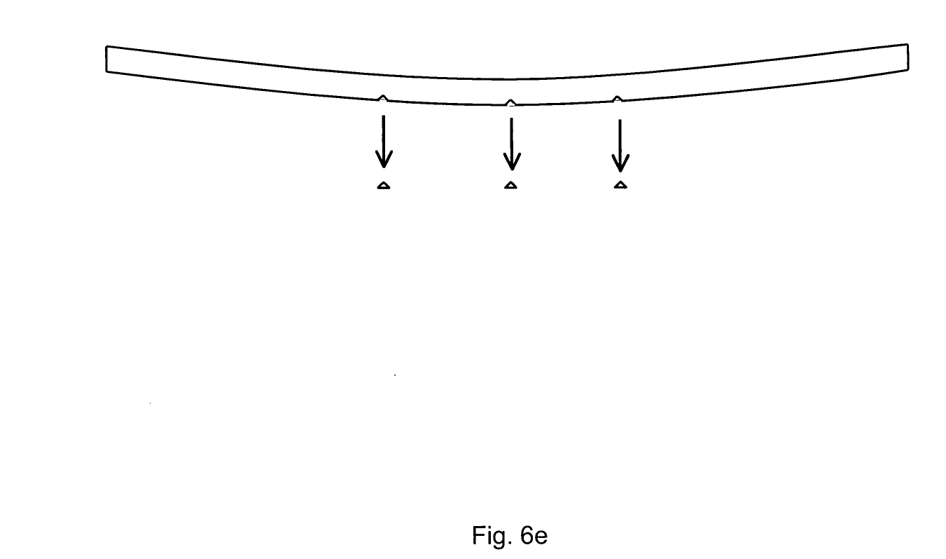

Another advantage of the use of the flexible elastomeric tools of this invention is illustrated in FIGS. 6a through 6e. As illustrated in the Figure, the flexible elastomeric tools of the invention are advantageously used in pairs wherein the polymeric device is produced by molding between the two elastomeric tools. FIGS. 6a through 6c illustrate the molding process, substantially similar to the molding process shown in FIG. 4. FIG. 6a shows top and bottom tools where at least recesses in the top tool are included. Optionally raised matching features may exist in the bottom tool. The size and shape of the features do not need to be exactly the same. FIG. 6b shows these two tools with a charge of resin inserted between them. FIG. 6c shows the resin after the application of heat and compression force. FIG. 6d shows the two tools subsequently separated from the part. FIG. 6d also illustrates the common occurrence that pieces of thermoplastic resin, called tear tabs, can remain on the surface of one (or both) of the elastomeric tools. This is significant, because in injection molding and hard embossing it is very difficult to remove the tear tabs from the tool, and the tool cannot be used again when they are present. In contrast, FIG. 6e shows that the tear tabs are easily removed from the flexible elastomeric tools of this invention simply by flexing the top tool, and the tool is ready to be reused.

Certain preferred embodiments of the apparatus of the invention are described in greater detail in the following sections of this application and in the drawings.

### EXAMPLE 1

This example describes the embossing of a thermoplastic diffraction grating using an elastomeric tool.

The elastomer was a commercially available silicone (Sylgard 184, obtained from Dow Corning, Midland, Mich.). The tool was formed by mixing one part of initiator to 10 parts of base compound, pouring the resin over the ruled surface of commercially available glass diffraction grating (Product Number 46-067, obtained from Edmund Optics, Barrington, N.J.) and curing the system at 70° C. for 2 hours. The ruled surface of this grating has a nominal periodicity of 14.29 μm. After this cure, the elastomeric tool was peeled from the glass master and then trimmed to yield a total area of approximately 36 cm². The next steps consisted of placing the tool on a chrome plate, placing the assembly on the lower temperature-controlled platen of an embossing station, adding a few grams of acrylic resin beads (VOD-100, obtained from Atofina, Philadelphia, Pa.) to the microstructured surface of the elastomeric tool, placing a chrome plate on the upper temperature-controlled platen and bringing the two platens together under a defined temperature, force, and time (TFT) profile. In this example, the TFT profile consisted of first increasing the platen temperature from 20° C. to 190° C., then increasing the applied force from 0N to 500N and then maintaining the applied force at 500N for 1 minute. After this application of elevated force and temperature, the platens were cooled to room temperature and then separated. The elastomeric tool was then peeled from the acrylic part.

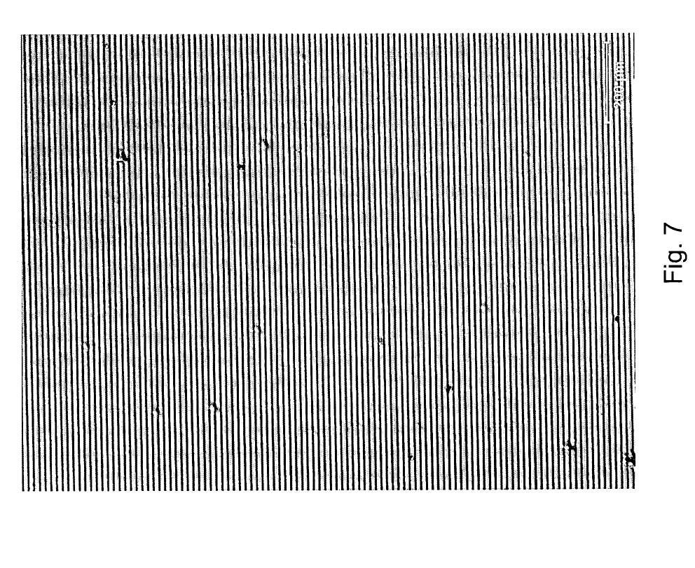

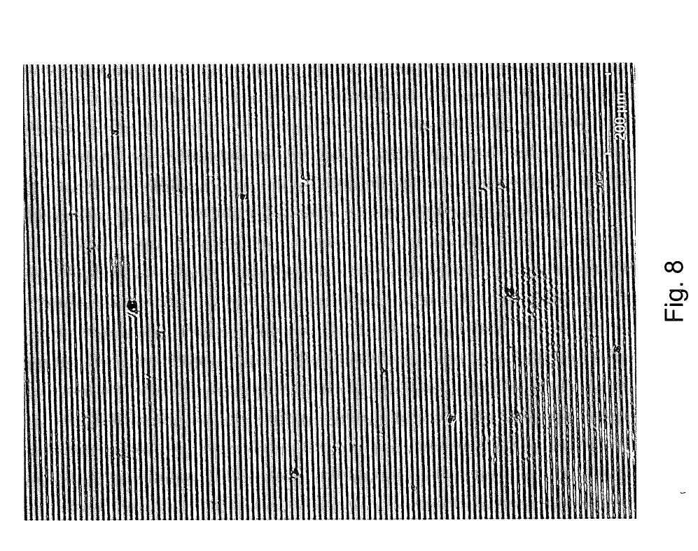

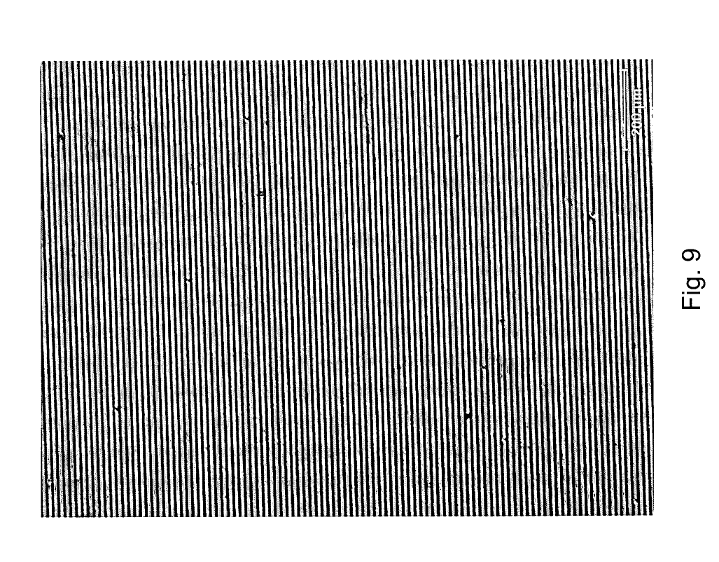

FIGS. 7, 8 and 9 are plan views of the glass grating, silicone tool and the corresponding acrylic grating, respectively, recorded with a stereomicroscope (SMZ 1500, obtained from Nikon. Melville, N.Y.) and a digital camera (model 3.2.0, obtained from Diagnostics Instruments, Inc., Sterling Heights, Mich.). Each micrograph shows a similar grating periodicity which is an indication of the high fidelity that can be obtained from this fabrication approach.

In order to further assess the microstructure fidelity, diffraction patterns were also recorded and compared for the master, silicone tool and acrylic part. These diffraction measurements were performed in the transmission mode with a HeNe laser operating at a wavelength of 543.5 nm. The diffraction pattern was allowed to project onto an opaque surface and by measuring the distance from the main beam and the various peaks and also the distance from the grating and the opaque surface a diffraction angle could be determined. It was found, for example, that the tenth order diffraction peak scattered at 21.39 degrees, 21.62 degrees and 21.06 degrees for the master, silicone tool and acrylic part, respectively. Using the standard grating equation, these measurements were used to determine a grating spacing of 14.90 μm for the glass master, 14.75 μm for the silicone tool and 15.12 μm for the acrylic part. The 1 percent linear shrinkage between glass master and silicone tool is consistent with product literature for this elastomer. The 2.5 percent linear expansion that occurs during embossing shows that the tool does expand during the embossing process. It is expected that tool expansion would decrease with the use of higher durometer elastomers and lower applied pressures and would increase with lower durometer elastomers and higher applied pressures.

### EXAMPLE 2

This example describes the use of elastomeric tools to emboss microdivots within a thermoplastic substrate.

A master was produced by spin coating an epoxy resist onto a silicon wafer, exposing the wafer with UV light under a chrome mask with various baking and washing steps. A commercial spin coater (Model P6700, obtained from Specialty Coating Systems, Inc., Indianapolis, Ind.) was used. The details of this approach included spinning a photoresist primer (1,1,1,3,3,3-Hexamethyldisilazane, obtained from J. T. Baker, Phillipsburg, N.J.) on a polished 125 mm silicon wafer (obtained from Silicon, Inc., Boise, Id.) at 4000 rpm, spinning an epoxy resist (SU-8 50, obtained from MicroChem, Newton, Mass.) at 500 rpm for 20 seconds followed by 1200 rpm for 25 seconds, prebaking the resist on a programmable digital hotplate (Dataplate, obtained from Barnstead International, Dubuque, Iowa) by ramping to 105° C. at 50° C./hour, cooling to 40° C. at 50° C./hour, exposing the resist through a chrome mask patterned on a quartz substrate with 200 μm by 200 μm and 100 μm by 100 μm transparent squares using a UV lamp exposure system (Hybralign Series 400 alignment and exposure system, obtained from Optical Associates Inc., Milpitas, Calif.) for 90 seconds at 7.4 mW/cm², postbaking the resist using the prebake temperature profile and developing the resist in PGMEA (Baker BTS-200 Edge Bead Remover, obtained from J. T. Baker) for approximately 15 minutes.

The elastomeric tool was creating by mixing a 10 to 1 ratio (by weight) of base compound and initiator of a high durometer silicone (product numbers KE-1600 and CX-832-085-1, obtained from Shin Etsu, Akron, Ohio), pouring the mixed silicone over the master and allowing the silicone to cure in an evacuated bell jar overnight at room temperature. After this cure, the elastomeric tool was peeled from the glass master and then trimmed to yield a total area of approximately 108 cm². The next steps consisted of placing the tool on a chrome plate, placing the assembly on the lower temperature-controlled platen of an embossing station, adding a premolded sheet of polypropylene (Finplas 1471, obtained from Atofina), cut to an approximate dimension of 1 mm×80 mm×80 mm, onto the microposts of the elastomeric tool, placing a chrome plate on the upper temperature-controlled platen and bringing the two platens together under a defined TFT profile. In this example, the TFT profile consisted of first increasing the platen temperature from 20° C. to 170° C., then increasing the applied force from 0N to 500N and then maintaining the applied force at 500N for 1 minute. After this application of elevated force and temperature, the platens were cooled to room temperature and then separated. The elastomeric tool was then peeled from the polypropylene part.

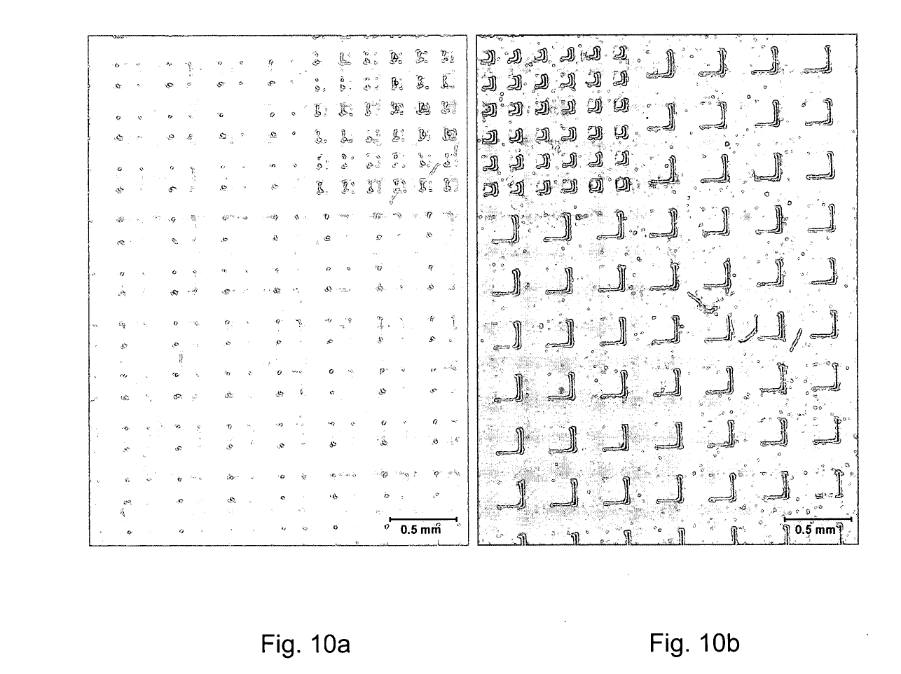

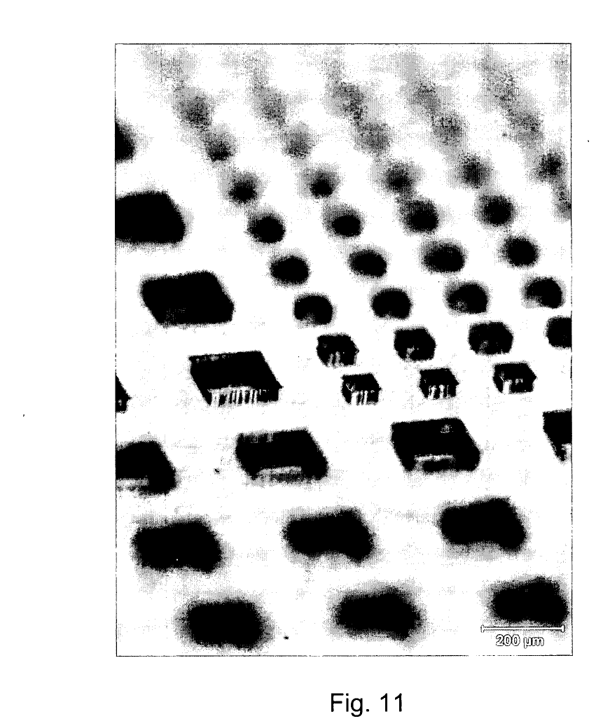

FIGS. 10 and 11 are optical micrographs taken with the set-up described in example 1. FIG. 10a is a plan view of the elastomeric tool and FIG. 10b is a plan view of the embossed polypropylene part. FIG. 11 is an oblique view of the polypropylene part that was taken by rotating the part 65 degrees from the normal to the part taken in the plan view. While the plan views show a good dimensional correspondence between elastomeric tool and embossed part, the oblique view shows that the features extend below the surface and are, in fact, divots.

### EXAMPLE 3

This example describes the use of elastomeric tools to emboss microposts on a thermoplastic substrate.

The elastomeric tool described in Example 2 was first used to create a daughter elastomeric tool. To accomplish this replication the parent tool was placed in a plasma system (model 500-II, obtained from Technics West, San Jose, Calif.) and exposed to ambient gas plasma operating at 100 Watts for 1 minute. The effect of this plasma treatment was to create reactive sites on the surface of the elastomeric tool. The tool was then placed in an evacuated bell jar with a few drops of a fluoroinated silane (tridecafluoro-1,1,2,2,-tetrahydryloctyl-1-trichlorosilane, obtained from United Chemical Technologies, Bristol, Pa.) for a few hours. The effect of this treatment was to react the surface of the elastomeric tool with the fluorinated silane, thereby creating a non-stick elastomeric surface. After this fluorosilane treatment, silicone (Sylgard 184, obtained from Dow Corning), mixed in a 10:1 ratio as described in example 1 and subsequently degassed, was poured onto the surface of the parent elastomeric tool and allowed to cure at 70° C. for approximately 1 hour. The cured silicone layer was then peeled from the parent elastomeric surface in order to create a daughter tool with microdivots.

Prior to embossing the silicone tool was trimmed to an area of approximately 66 cm². The embossing procedure consisted of placing the tool on a chrome plate, placing the assembly on the lower temperature-controlled platen of an embossing station, adding a premolded sheet of polypropylene (Finplas 1471, obtained from Atofina) onto the microdivots of the elastomeric tool, placing a chrome plate on the upper temperature-controlled platen and bringing the two platens together under a defined TFT profile. In this example, the TFT profile consisted of first increasing the platen temperature from 20° C. to 170° C., then increasing the applied force from 0N to 500N and then maintaining the applied force at 500N for 1 minute. After this application of elevated force and temperature, the platens were cooled to room temperature and then separated. The elastomeric tool was then peeled from the polypropylene part.

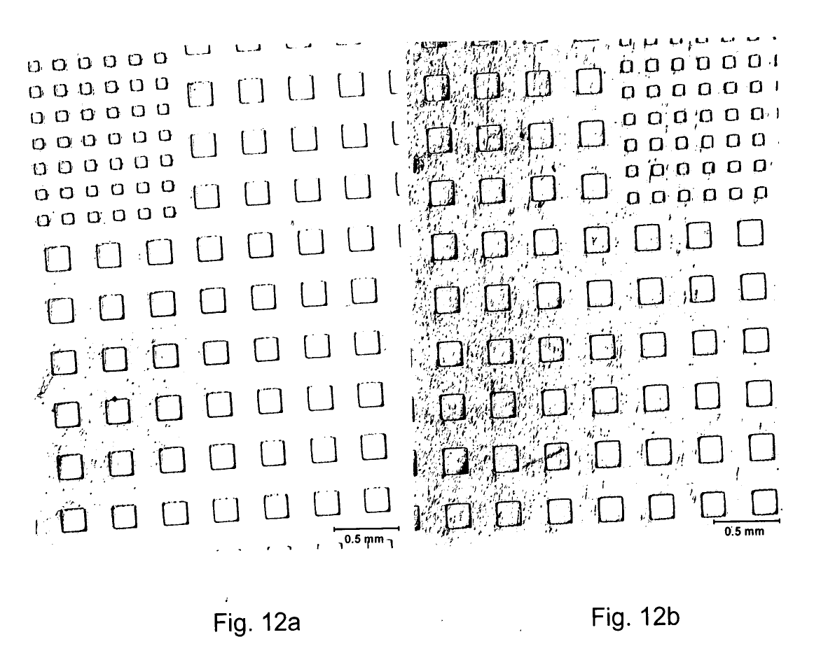

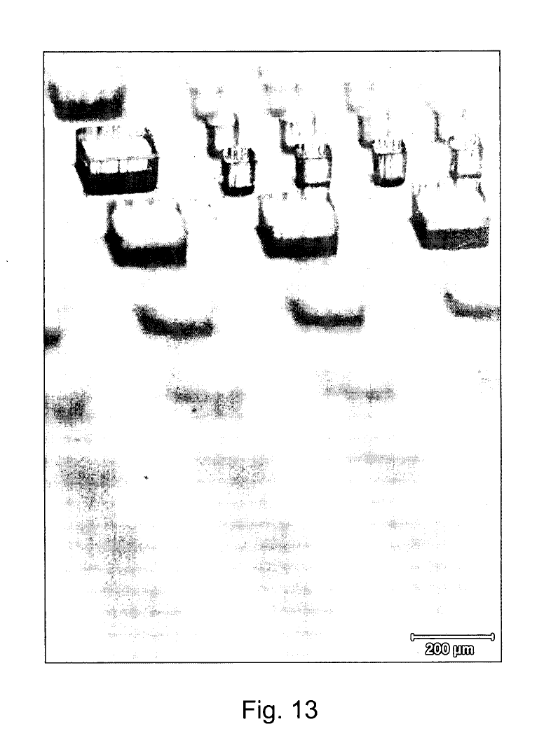

FIGS. 12 and 13 are optical photomicrographs taken with the set-up described in Example 1. FIG. 12a is a plan view of the elastomeric tool and FIG. 10b is a plan view of the embossed polypropylene part. FIG. 13 is an oblique view of the polypropylene part that was taken by rotating the part 67 degrees from the normal to the part taken in the plan view. While the plan views show a good dimensional correspondence between elastomeric tool and embossed part, the oblique view shows that the features extend below the surface and are, in fact, posts.

### EXAMPLE 4

This example describes the use of an elastomeric tool to emboss a microfluidic device, comprised solely of microchannels in a thermoplastic substrate.

A master was produced by spin coating an epoxy resist onto a silicon wafer, exposing the wafer with UV light under a chrome mask with various baking and washing steps. This particular master contained 96 individual devices arrayed around the circumference of a 150 mm diameter silicon wafer. Each of the 96 devices contained three channels, each with 50 μm depths and 50 μm widths, that met in a common trench with a depth of 100 μm and a width of a 150 μm. The master was purchased from Applied MicroSwiss (Buchs, Switzerland).

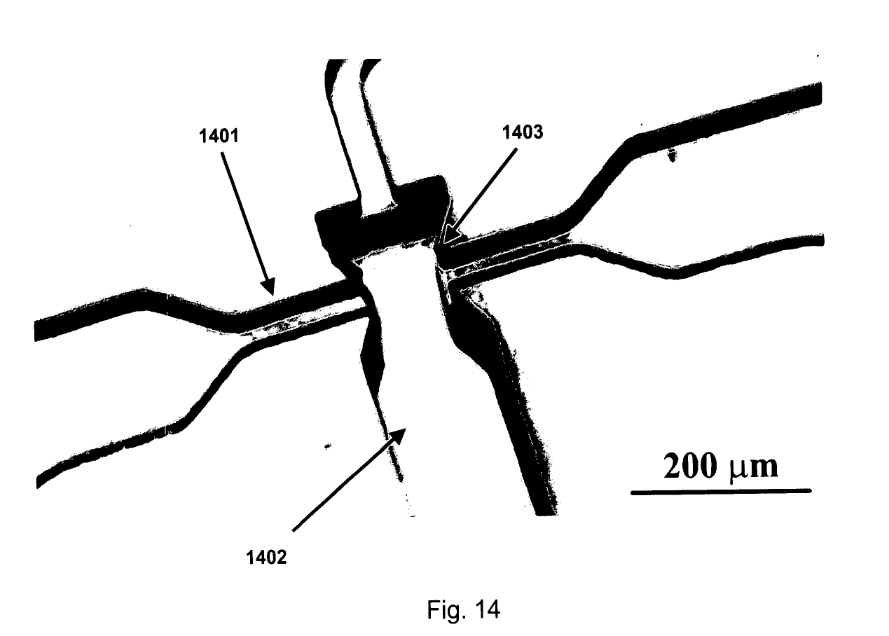

The elastomeric tool was creating by mixing a 10 to 1 ratio (by weight) of base compound and initiator of a high durometer silicone (product numbers KE-1600 and CX-832-085-1, obtained from Shin Etsu, Akron, Ohio.), pouring the mixed silicone over the master and allowing the silicone to cure in an evacuated bell jar overnight at room temperature. The cure silicone was then peeled from the master. After this cure, the elastomeric tool was peeled from the epoxy/silicon master and then trimmed to yield a total area of approximately 180 cm². The next steps consisted of placing the tool on a chrome plate, placing the assembly on the lower temperature-controlled platen of an embossing station, adding resin chips of cyclic olefin copolymer (Topas 8007 X10, obtained from Ticona), placing a chrome plate on the upper temperature-controlled platen and bringing the two platens together under a defined TFT profile. In this example, the TFT profile consisted of first increasing the platen temperature from 20° C. to 170° C., then increasing the applied force from 0N to 3000N and then maintaining the applied force at 3000N for 10 minutes. After this application of elevated force and temperature, the platens were cooled to room temperature and then separated. The elastomeric tool was then peeled from the cyclic olefin copolymer part. FIG. 14 shows an oblique view of a section of the embossed part; the channel 1401 has symmetric cross-sectional dimension close to 50 μm while the trench 1402 has a depth and width of approximately 100 μm and 150 μm, respectively. When used in a centrifugal microfluidic device, the junction 1403 between the channel and trench is also called a capillary valve since it has the ability to retain fluids in the channel until the centrifugally developed fluid pressure exceeds a defined value. It is worth noting that the embossed part retains the smooth finish of the epoxy/silicon master and elastomeric tool.

### EXAMPLE 5

This example describes the repeated use of an elastomeric tool to emboss a microfluidic manifold, comprised of microchannels, reservoirs and cuvettes, in a thermoplastic substrate.

The master was designed using a commercial 2-dimensional drawing package (AutoCAD, obtained from Autodesk, San Rafael, Calif.); cutting depths, feed rates and spindle speeds were assigned to the 2-D pattern and then converted to numerical code that was readable by a CNC milling station (Benchman XT, obtained from Intelitek, Manchester, N.H.). The master was subsequently machined in a ¼ inch×6 inch×12 inch piece of cast acrylic (Plexiglas; Atofina) using this CNC station with tools that ranged in diameter from 127 μm to 1.27 cm. The particular design consisted of 96 microfluidic manifolds arrayed around the circumference of a disc with overall form factor close to a compact disc. The various microchannels had lateral and depth dimensions ranging from one to several hundred microns while the reservoirs and cuvettes had lateral and depth dimensions ranging from a fraction of a millimeter to a few millimeters.

The elastomeric tool was creating by mixing a 10 to 1 ratio (by weight) of base compound and initiator of a high durometer silicone (product numbers KE-1600 and CX-832-085-1; Shin Etsu), pouring the mixed silicone over the master and allowing the silicone to cure in an evacuated bell jar overnight at room temperature. The cured silicone was then peeled from the master. The next steps consisted of placing the tool in a metal frame that was mounted on the lower temperature-controlled platen of an embossing station, securing the tool on the platen surface with the application of vacuum, adding defined of amount of thermoplastic material to the elastomeric tool surface, securing a polished silicon wafer on the upper temperature-controlled platen with the application of vacuum and bringing the two platens together under a defined TFT profile. The TFT profile used consisted of first increasing the platen temperature from 20° C. to a temperature well above the glass transition temperature of the thermoplastic material, then increasing the applied force from 0N to 3000N and then maintaining the applied force at 3000N for 7 minutes. After this application of elevated force and temperature, the platens were cooled to room temperature and then separated. The elastomeric tool was either peeled from the thermoplastic part or separated from the rigid part with the aid of a brief blast of air to the backside of the elastomeric tool.

In this example, the investigated thermoplastic materials included injection-moldable grades of acrylic resin (VOD-100; Atofina), polystyrene (Crystal PS 1510, obtained from Nova Chemicals, Monaca, Pa.), an acrylic copolymer (NAS30, obtained from Nova Chemicals) and polypropylene (Finplas 1471; Atofina). Acrylic microfluidic manifolds were formed by adding 35 grams of loose resin beads, sintered pucks of resin beads or premolded sheet onto the elastomeric tool and following the protocol defined above with a forming temperature of 190° C. Polystyrene and acrylic copolymer microfluidic manifolds were formed by stacking two premolded 2 inch by 3 inch by ¼ inch sheets on top of the bottom structured elastomeric tool and following the protocol defined above with a forming temperature of 190° C. For polypropylene the above protocol was followed and 170° C. was chosen as the forming temperature. All of the structures reported in this example were fabricated from the same elastomeric tool.

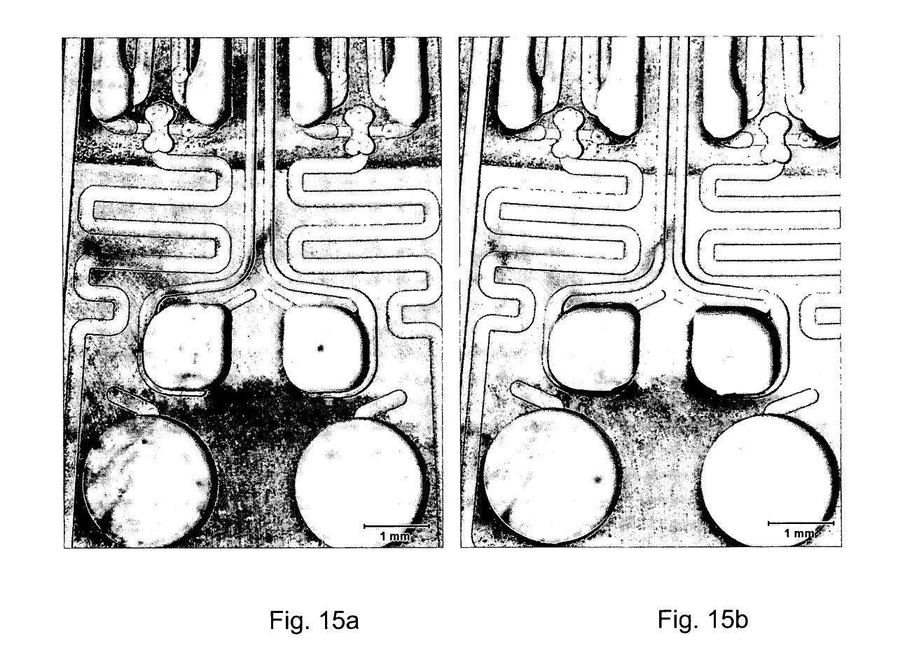

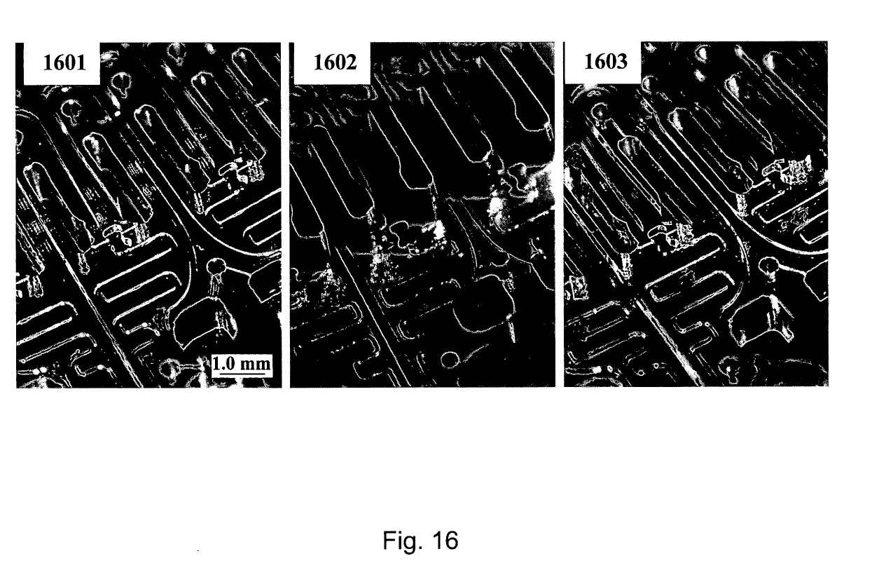

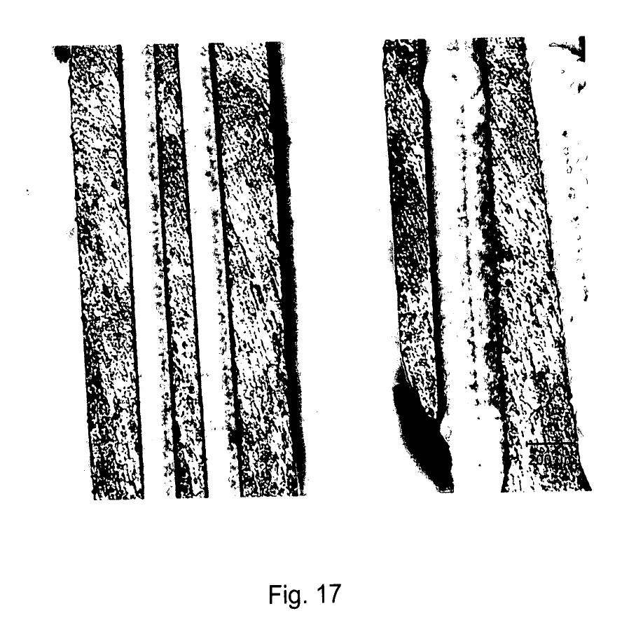

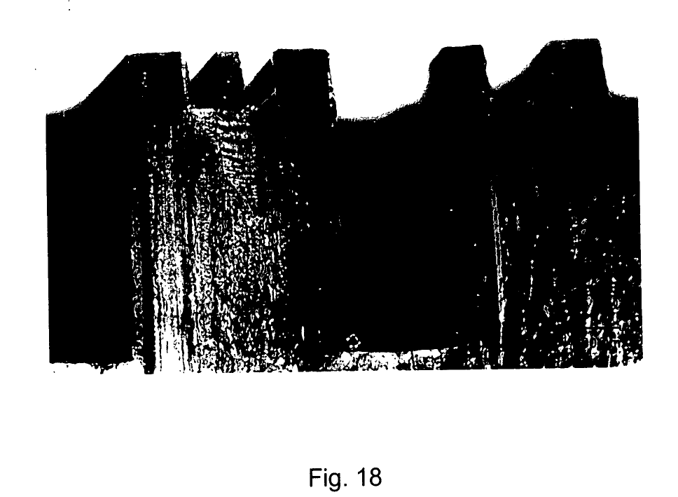

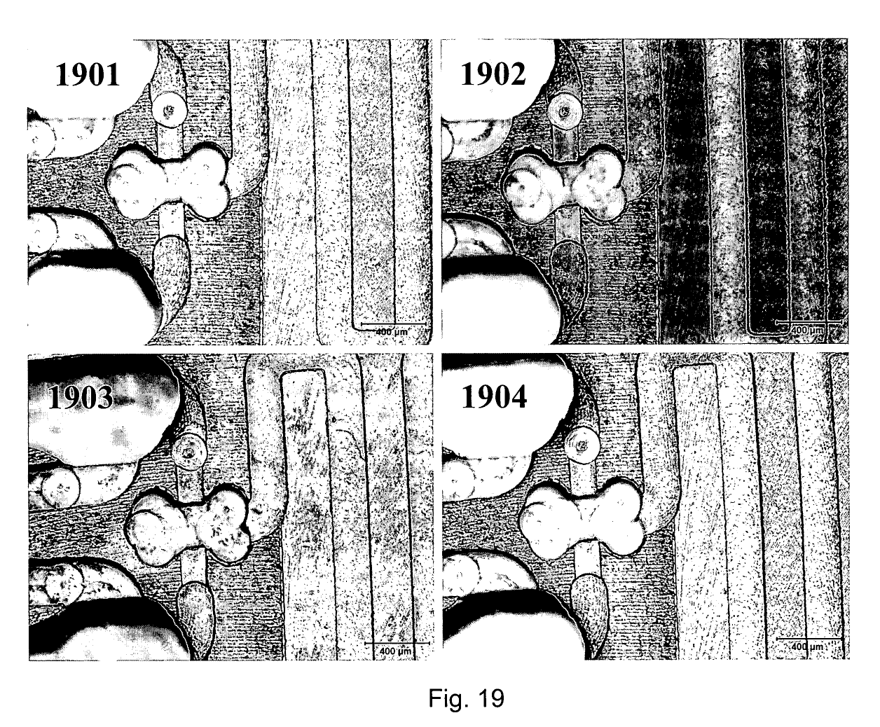

FIGS. 15 through 20 are optical photomicrographs taken with the set-up described in Example 1. FIG. 15a is a plan view of the machined acrylic master and FIG. 15b is a plan view of the embossed acrylic part that shows the high fidelity of this replication approach. In fact, micron-size machine marks and debris in the acrylic master were even found in the embossed part. FIG. 16 demonstrates the concept shown earlier in the line drawing of FIG. 3, however, this time with an actual master 1601, elastomeric tool 1602 and acrylic part 1603. FIG. 17 shows a plan view of an embossed acrylic microstructure and FIG. 18 shows a cross-sectional view of this same region (and same microstructure). FIG. 18, in particular, demonstrates that this embossing approach can be used to fabricate not only small features and not only large features, but also small and large features on the same substrate from a single elastomeric tool. FIG. 19 shows plan views of corresponding sections of the acrylic master (1901; top left), embossed polypropylene part (1902; top right), embossed polystyrene part (1903; bottom left) and embossed acrylic copolymer part (1904; bottom right). The fact that the same machining marks and defects can be seen in all of these images and that these images were taken of sections of the master and parts that should correspond, highlight the high fidelity and repeatability that is attainable with this replication process for a wide range of materials and process conditions.

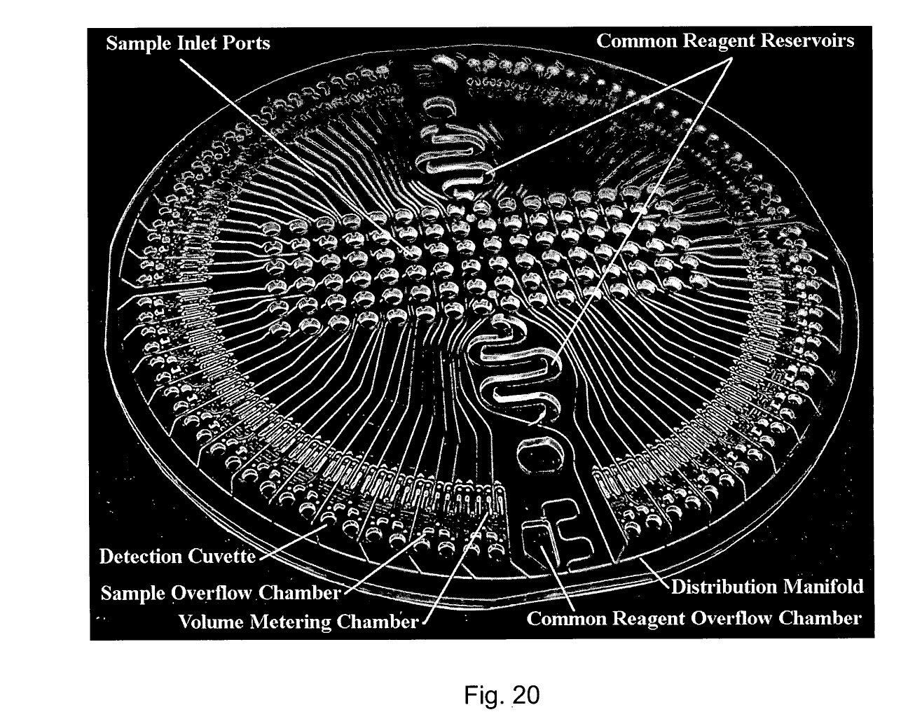

FIG. 20 shows an oblique view of an embossed polypropylene disc with a number of fluidic and microfluidic features, including sample inlet ports, common reagent reservoirs, distribution manifolds, volume metering chambers, sample overflow chambers. The microfluidic function of this type of disc is described more fully in Example 11 below. FIG. 20 demonstrates the use of an elastomeric tool to fabricate microstructures and macrostructures on the same part, where the part has overall diameter of approximately 125 mm and a thickness of at least 2 mm.

### EXAMPLE 6

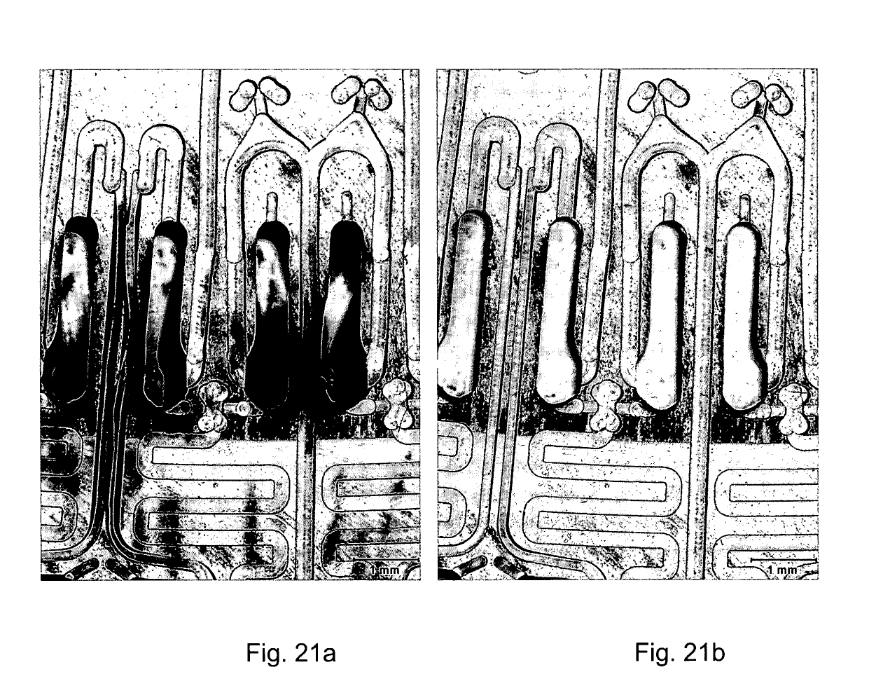

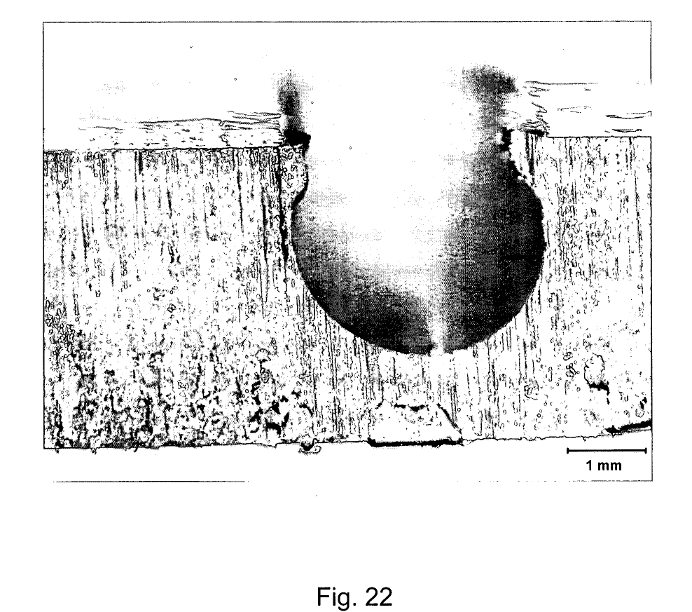

This example shows the resilience of the elastomeric tool. Compact disc grade polycarbonate premolded sheet was trimmed and added to the elastomeric tool (1602) of Example 5. The embossing recipe of Example 5 was also chosen with a forming temperature of 190° C. FIG. 21a shows a plan view of a section of the embossed microfluidic manifold. Unlike many of the micrographs referred to in Example 5, this figure depicts distorted microchannels, reservoirs and cuvettes which were brought about by the application of too high an embossing pressure and too little thermal energy to the polycarbonate substrate; in this case, instead of freely flowing around the raised microfeatures of the elastomeric tool during the embossing process, the raised microfeatures deformed and this deformation was captured in the embossed part. A few minutes following the fabrication of this polycarbonate part, an acrylic substrate (VOD-100; Atofina) was embossed using the same elastomeric tool and same process schedule. FIG. 21b shows a plan view of this acrylic part ; note that the regions shown in FIGS. 21a and 21b correspond to the same region on the elastomeric shim; the fact that little or no deformation can be seen in FIG. 21b shows that the elastomeric tool is resilient.

### EXAMPLE 7

This example describes embossing and demolding parts with reentrant features. A reentrant structure was machined in a piece of cast acrylic using a commercially available ball end-mill (Tool Number 28908, obtained from Harvey Tool, Topsfield, Mass.). An elastomeric tool was fabricated against this acrylic master using Shin Etsu silicone and the methods described in the above examples. This tool was subsequently trimmed to an area of approximately 16 cm² and secured to the upper platen of the embossing station with the application of vacuum. An elastomeric ring was placed on the lower platen after the addition of approximately 30 grams of acrylic resin beads to the interior of the ring the embossing schedule of Example 5 with an embossing parameters appropriate to acrylic resin was followed. After embossing, the tool was peeled from the part without any damage to either. FIG. 17 shows a cross-sectional view of the embossed, reentrant structure. This example demonstrates that elastomeric tools can be used to emboss and separate parts with reentrant features without damage to the tool or part.

### EXAMPLE 8

This example describes the use of two embossing tools to form features on either side of a thermoplastic part.

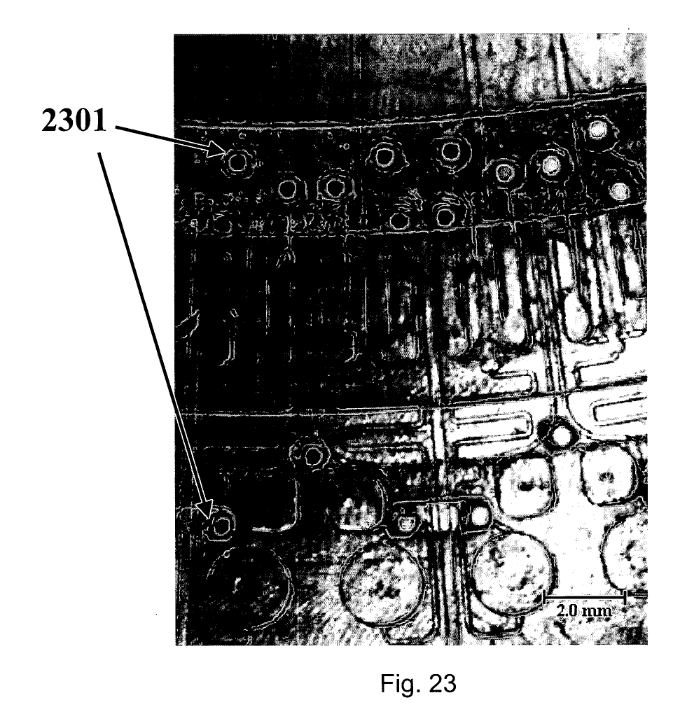

The approach described in Example 5 was used to generate two acrylic masters; both masters were designed to produce elastomeric tools; one master was designed to produce a tool that was placed on the lower platen of the embossing station and used to emboss a microfluidic manifold and begin the fabrication of through-holes into a preformed acrylic (VOD-100; Atofina Pa.) substrate. In addition to the microfluidic structures, the tool included posts with diameters of 0.4 mm and heights of 0.6 mm. The other master was designed to produce a tool that was placed on the upper platen of the embossing station and used to complete the through-holes in the same preformed acrylic substrate. This tool primarily consisted of raised bands with lateral dimensions ranging from a few millimeters to several centimeters and heights equal to 1.4 mm. The arrangement of these bands was designed such that during the embossing process they were well mated to the posts of the opposing tool. The use of opposing tools in this manner creates through-holes in the embossed part or regions of very thin plastic that are easily punched and opened. FIG. 23 shows a plan view of an embossed part with complete through-holes 2301 that were fabricated using these two opposing tools.

This example also shows that microfluidic manifolds on either side of an embossed part can be formed, allowing multiple fluidic layers and increased fluidic density in a given area.

### EXAMPLE 9

This example describes bonding of an unstructured lid to a structured fluidic device or the bonding of several embossed fluidic devices to create a multilayer device.

Embossed microfluidic discs were bonded to embossed or machined lids via thermal diffusion bonding To produce embossed lids, a master was first created using the machining approaches outlined in example 5; silicone elastomer was then mixed, degassed, poured and cured in this master. The resulting tool consisted of a 124 mm diameter disc shaped trench with a depth of approximately 2 mm; this trench also contained two 12 mm diameter, 2 mm high posts located along a common diameter, each at a radius approximately 42 mm. Methods similar to those described in example 5 were also used to thermoform lid. The resulting lids had an overall diameter of 124 mm, a thickness of 2 mm, with two 12 mm diameter through-holes located along a common diameter, each at a radius of approximately 42 mm. The machining methods described in example 5 were also used to produce lids with comparable dimensions. The two 12 mm diameter through holes were used to grip the device and allow rotation of the disc about its center.

Bonding the part and lid consisted of aligning the two pieces at their common through-holes and then placing the assembly between two temperature controlled platens mounted in a pneumatically controlled press (Model C, obtained from Carver, Inc., Wabash, Ind.). Unlike the embossing press used in the examples above, this bonding press did not provide force control during the bonding process. An initial force of approximately 650N was applied to the assembly and the temperature was gradually increased to a value close to the glass transition temperature of the polymeric resin. For acrylic and polypropylene resins, a temperature of 115° C. was used; for bonding cyclic olefin copolymer parts and lids, the bonding temperature was close to 80° C. At these bonding temperatures, the applied force remained fairly constant with a value close to 2000N. After several minutes of elevated temperature and force, the assembly was cooled to room temperature, the clamping force was released and the part was removed from the press.

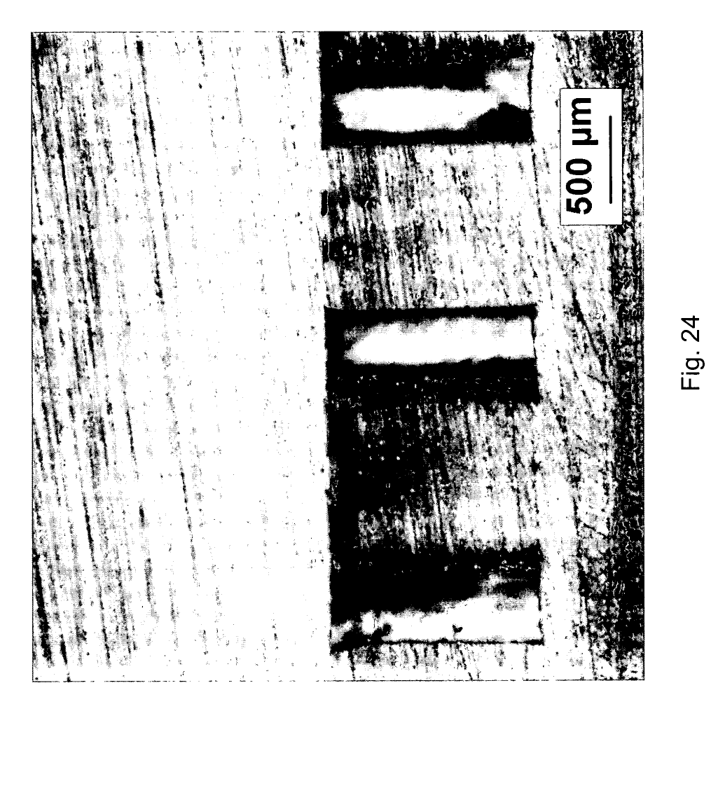

FIG. 24 shows a cross-sectional view of embossed, and structured, acrylic part that had been subsequently sealed with an embossed, yet unstructured, acrylic lid. This example also shows that it is possible to join two or more embossed, and structured, parts, and with the appropriate use of through-holes and alignment marks, to create three-dimensional microfluidic networks. In such a case, the fluid travel is limited not to just a single layer but may travel between the different layers. A particular advantage of a three-dimensional network over the previously described two-dimensional networks is the possibility of increasing the density of fluidic functions for a given device.

### EXAMPLE 10

To characterize the precision of this embossing approach, flow rate measurements were performed on discs embossed with a simple microfluidic design. The design consisted of a large feed reservoir connected to a narrow, shallow and long (and resistive) serpentine channel (127 μm wide by 127 μm deep by 34.6 cm long) which, in turn, was connected to a wider and deeper (254 μm wide by 254 μm deep) and less resistive measurement channel. A total of 27 acrylic discs, each containing 3 copies of this fluidic design, were embossed, bonded to cast acrylic lids, and subsequently, used for these flow rate measurements. Embossing and bonding procedures used the methods outlined in the examples above. The fluid consisted of deionized water, with a small amount of food coloring added to enhance the visualization. Discs were rotated about their centers at 475 revolutions per minute and the flow of liquids on the discs was monitored using a stroboscopic video microscopy set-up; flows were captured on videotape and reanalyzed post-measurement. By measuring the time required for the leading edge of the fluid to traverse a known distance through the measurement channel, it was possible to a calculate volumetric flow rate of fluid leaving the serpentine channel.

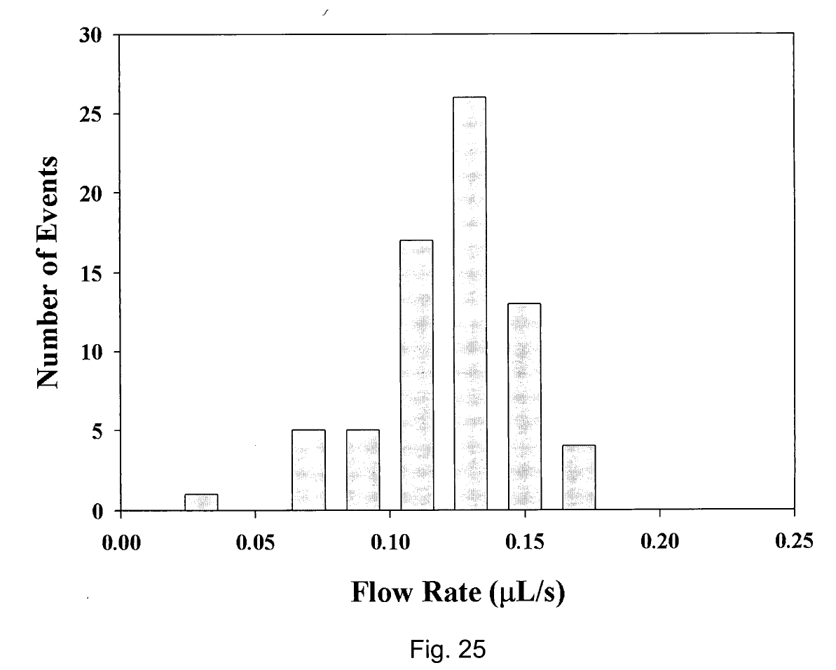

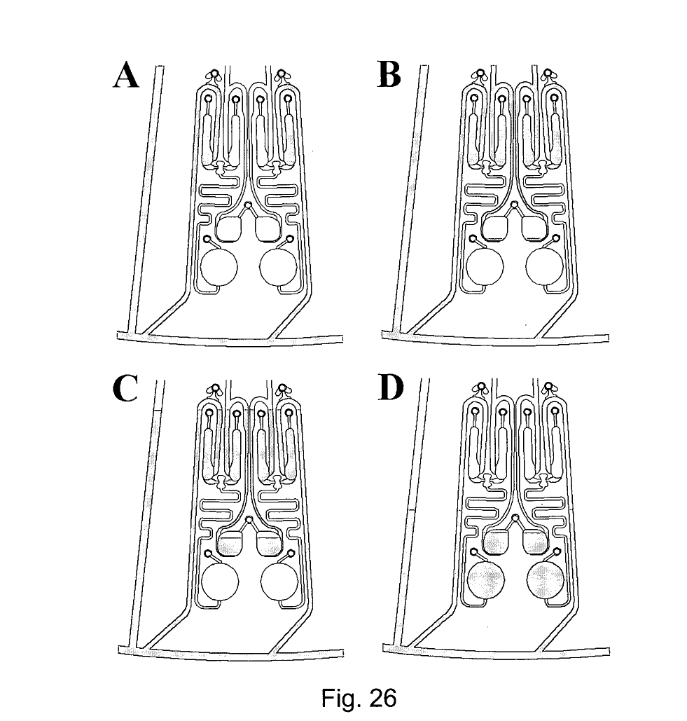

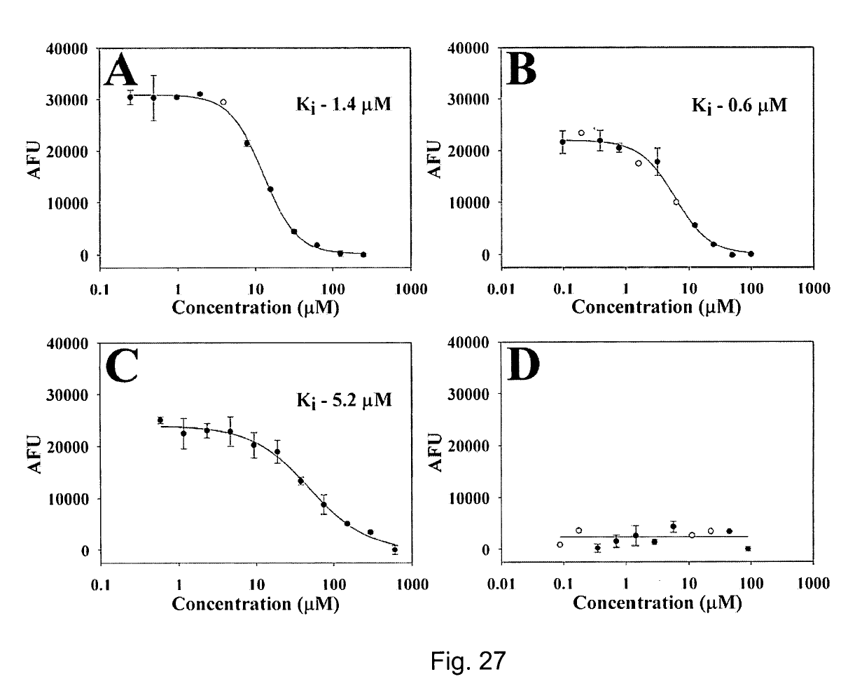

FIG. 25 is a histogram plot of the measured flow rates through this simple microfluidic design. Approximately 80% of the measured values fall within plus or minus 20% of the mean flow rate. Since flow rate is inversely proportional to the length of the channel and inversely proportional to fourth power of the cross-sectional dimension of the channel (depth or width), and further, since the serpentine channel length was measured to remain constant (to within less than 1% deviation) between fabricated designs, the plus or minus 20% variance in flow rates was attributable to a plus or minus 5% variance in average cross-sectional dimensions between the different fabricated designs. This variance is not large, especially considering that each serpentine channel occupied nearly a third of the outer circumference of a 124 mm diameter disc. It is also reasonable to expect this variance to decrease through the use of improved TFT profiles during the bonding process or through the use of alternative lidding methods (e.g., by applying lids with pressure sensitive adhesive).

### EXAMPLE 11

This example describes the use of centrifugal force to drive fluids through microfluidic discs to simultaneously perform 96 drug-protein binding assays.

Discs were embossed and bonded from acrylic (VOD-100 obtained from Atofina) using the methods described in the previous examples. Final discs were similar in layout to the example shown in FIG. 20.

The drug-protein binding assay is based on the competitive displacement of a fluorescent probe (quinaldine red, QR) from a serum protein (α1-acid glycoprotein, αAGP) by a drug,. The assay involved mixing a metered volume of drug compound dissolved in the appropriate buffer with a metered volume of a mixture of QR and αAGP and measuring the decrease in fluorescent signal as the drug displaced the fluorescent probe from the serum protein. Four different drug concentration series were prepared in a microtiter plate, in which stock drug concentrations were diluted 1:100 and then serially diluted 1:2 in HEPES buffer. Ten concentrations plus positive (same concentration as dilution one) and negative (no drug) controls were prepared for each drug. The final DMSO concentration for each case was maintained at 1%. Three of the drugs, chloropromazine, tri-idiobenzoic acid, and lidocaine are known inhibitors to QR/αAGP binding and had stock concentrations of 50 mM, 20 mM and 1 M, respectively. The fourth drug, ibuprofen, is known to be a non-binder for QR/αAGP and had a stock concentration of 18 mM. A solution of 10 μM αAGP and 40 μM QR was prepared in HEPES buffer with 1% DMSO. All reagents were obtained from Sigma Chemical Co. (St. Louis, Mo.).

Ten serial dilutions plus positive and negative controls were performed in duplicate for four different drugs on a single microfluidic disc. 3.25 μl of each dilution was pipetted manually into the inlet ports of the microfluidic disc such that each quadrant of the disc contained dilutions of a different drug. Each quadrant therefore represented two 10-point dilution curves for the same drug with two positive and two negative controls. 160 μl of the QR/αAGP solution was loaded into each of the two common reagent reservoirs.

A commercially available fluorescence reader that could also spin individual discs was used for spinning and reading functions (Tecan LabCD Ultra™ obtained from Tecan Group Ltd., Mannedorf, Switzerland). The main fluidic steps are outlined, in sequential fashion, in FIG. 23. Spinning a disc at approximately 450 rpm for 30 seconds delivered the QR/αAGP solution from the common reagent reservoir, through the distribution manifold to a volume metering chamber (FIG. 26a); spinning the disc at 600 rpm for 30 seconds defined the QR/αAGP solution volume (2 μl) and delivered the drug compound solution to an adjacent volume metering chamber, where any volume over 2 μl was transferred to a sample overflow chamber (FIG. 26b and FIG. 26c); this particular design used capillary valves to hold the QR/αAGP solutions and drug compound solutions in their respective chambers; finally, spinning the disc at 2000 rpm for 30 seconds provided enough pressure to release the capillary valve and deliver the metered volumes of QR/αAGP solution and drug compound solution through a common mixing channel to a common detection cuvette (FIG. 26d). The disc was then incubated at 37° C. for 6 minutes in the instrument to allow equilibrium of mixing, binding and temperature. Fluorescence measurements were made using a multi-purpose filter based reader with 1 mm illumination spot size and the capability to make rapid fluorescence measurements as a disc spins beneath the optical head. The fluorescence signal generated in each detection cuvette of the a disc was measured with an excitation wavelength of 520 nm and an emission wavelength of 630 nm. Curve fits of the resulting data were based on a standard four parameter logistic method. FIG. 24 shows the fluorescence intensity as a function of drug compound concentration for chloropromazine (FIG. 24a), tri-idiobenzoic acid (FIG. 24b), lidocaine (FIG. 24c) and ibuprofen (FIG. 24d), along with the corresponding model fits and binding constants.

The binding constants obtained with this centrifugal microfluidic device were similar to those obtained from parallel assays performed in standard 96-well microplates. This example shows that elastomeric tools and processes provided by the present invention can be used to produce microfluidic parts that function as designed.

It should be understood that the foregoing disclosure emphasizes certain specific embodiments of the invention and that all modifications or alternatives equivalent thereto are within the spirit and scope of the invention as set forth in the appended claims.

We claim:

1. A flexible elastomeric tool for producing a polymeric device, wherein the tool comprises a base having a surface and the surface further comprises a negative replica of one or a plurality of structures, wherein impression of a thermoplastic resin at a temperature higher than the glass transition temperature of the thermoplastic resin produces the structures in a surface of the thermoplastic resin when it is cooled below its glass transition temperature.

2. The flexible elastomeric tool of claim 1, further comprising a lip around the perimeter of the base of the tool, wherein the lip extends above the surface of the base.

3. The flexible elastomeric tool of claim 1 wherein the base is disc-shaped.

4. The flexible elastomeric tool of claim 1 wherein the structures are fluidics structures or microfluidics structures, or both fluidics structures and microfluidics structures.

5. The flexible elastomeric tool of claim 4 wherein the microfluidics structures comprise one or a plurality of microchannels, reaction chambers, detection chamber, reagent reservoirs, and sample input means in fluidic contact.

6. A polymeric device comprised of a thermoplastic resin and comprising one or a plurality of structures produced using the flexible elastomeric tool of claim 1.

7. The polymeric device of claim 6, wherein the structures are fluidics structures or microfluidics structures, or both fluidics structures and microfluidics structures.

8. The polymeric device of claim 7 wherein the microfluidics structures comprise one or a plurality of microchannels, reaction chambers, detection chamber, reagent reservoirs, and sample input means in fluidic contact.

9. A polymeric device comprised of a thermoplastic resin and comprising one or a plurality of structures produced using a two or a plurality of the flexible elastomeric tools of claim 1, wherein the device is formed between two or a plurality of tools arranged to have the surface of each tool comprising the negative replica of the structures to be facing the surface of another tool comprising the negative replica of the structures.

10. A polymeric device according to claim 9, wherein the flexible elastomeric tools used in producing the device are aligned to place a negative replica on one tool of a portion of one or a plurality of structures in proximity to a negative replica on another tool of a portion of one or a plurality of structures, wherein the device comprises a said one or a plurality of structures formed by the proximal arrangement of the negative replicas on said tools.

11. A polymeric device according to claim 10, wherein the one or plurality of fluidics structures are through-holes.

12. The polymeric device according to claim 9 wherein the structures are fluidics structures or microfluidics structures, or both fluidics structures and microfluidics structures.

13. The polymeric device of claim 12 wherein the microfluidics structures comprise one or a plurality of microchannels, reaction chambers, detection chamber, reagent reservoirs, and sample input means in fluidic contact.

14. The polymeric device of claim 9 that is disc-shaped.

15. A method of producing a polymeric device comprising the step of injection molding a thermoplastic resin using a flexible elastomeric tool according to claim 1.

16. A method of producing a polymeric device comprising the step of hot embossing a thermoplastic resin using a flexible elastomeric tool according to claim 1.

17. A method of producing a polymeric device comprising the step of injection molding a thermoplastic resin using a pair of flexible elastomeric tools according to claim 1, wherein the pair of tools is arranged to have the surface of each tool of the pair comprising the negative replica of the structures to be facing the surface of the other tool of the pair comprising the negative replica of the structures.

18. A method of producing a polymeric device comprising the step of hot embossing a thermoplastic resin using a pair of flexible elastomeric tools according to claim 1, wherein the pair of tools is arranged to have the surface of each tool of the pair comprising the negative replica of the structures to be facing the surface of the other tool of the pair comprising the negative replica of the structures.

19. The method of claim 15, wherein the device is injected molding under conditions of reduced atmospheric pressure.

20. The method of claim 16, wherein the device is injected molding under conditions of reduced atmospheric pressure.

21. The method of claim 17, wherein the device is injected molding under conditions of reduced atmospheric pressure.

22. The method of claim 18, wherein the device is injected molding under conditions of reduced atmospheric pressure.

23. The method of claim 15, wherein the structures are fluidics structures or microfluidics structures, or both fluidics structures and microfluidics structures.

24. The method of claim 16, wherein the structures are fluidics structures or microfluidics structures, or both fluidics structures and microfluidics structures.

25. The method of claim 17, wherein the structures are fluidics structures or microfluidics structures, or both fluidics structures and microfluidics structures.

26. The method of claim 18, wherein the structures are fluidics structures or microfluidics structures, or both fluidics structures and microfluidics structures.

27. The method of claim 15, wherein the elastomeric tool is removed from the device after injection molding by flexing or deforming the tool.

28. The method of claim 16, wherein the elastomeric tool is removed from the device after hot embossing by flexing or deforming the tool.

29. The method of claim 17, wherein the elastomeric tools are removed from the device after injection molding by flexing or deforming the tool.

30. The method of claim 18, wherein the elastomeric tools are removed from the device after hot embossing by flexing or deforming the tool.

31. Two or a plurality of elastomeric tools for producing a polymeric device according to claim 9, wherein the tools are arranged to have the surface of each tool comprising the negative replica of the structures of the device to be facing the surface of another tool comprising the negative replica of the structures of the device.

32. The elastomeric tools of claim 31, wherein the pair of flexible elastomeric tools are adapted to be aligned to place a negative replica on one tool of a portion of one or a plurality of structures in proximity to a negative replica on another tool of a portion of one or a plurality of structures, whereby the device comprises a said one or a plurality of structures formed by the proximal arrangement of the negative replicas on said tools.

33. The elastomeric tools of claim 32, wherein the one or plurality of fluidics structures are through-holes.

34. The elastomeric tools of claim 31, wherein the structures are fluidics structures or microfluidics structures, or both fluidics structures and microfluidics structures.

35. The elastomeric tools of claim 34, wherein the microfluidics structures comprise one or a plurality of microchannels, reaction chambers, detection chamber, reagent reservoirs, and sample input means in fluidic contact.

36. The device of claim 9, wherein the device is produced using a pair of elastomeric tools.

37. The elastomeric tools of claim 31 comprising a pair of elastomeric tools.
